(19) United States
(12) Patent Application Publication
(10) Pub. No.: US 2003/0190181 A1
(43) Pub. Date: Oct. 9, 2003

(54) Apparatus and method for inputting alphabet characters on keypad

(76) Inventor: Min Kyum Kim, Seoul (KR)

Correspondence Address: Jonathan Y Kang, Lee & Hong, 221 N Figueroa Street 11th Floor, Los Angeles, CA, 90012-2501, US

(21) Appl. No.: 10/181,332

(22) PCT Filed: May 17, 2001
(86) PCT No.: PCT/KR01/00076

(51) Int. Cl. B41J 21/17

(52) U.S. Cl. 400/472; 400/70

(57) ABSTRACT

The invention is to efficiently input characters on a keypad and, more particularly, to input various symbols by using the hiding control processing method, thereby maintaining a simple arrangement of the keypad. Furthermore, the present invention produces simple codes using the relation between characters allocated to the keypad and numerals, implements the short-cut input method using the simple codes, and enters target characters and words or phrases with a small number of strokes using the concurrent input method. With a switching server for interpreting simple codes, the user can input simple codes even when the third server requests words or phrases other than simple codes, and the switching server interprets simple codes input by the user and sends the words or phrases corresponding to the simple codes to the third server, which does not store the simple codes and the words or phrases corresponding to the simple codes.

### BACKGROUND OF THE INVENTION

(a) Field of the Invention

The present invention relates to an apparatus and method for entering characters from a keypad. More specifically, the present invention relates to an apparatus and method for entering characters from a keypad having a small number of keys such as a telephone keypad

(b) Description of the Related Art

With the progress of mobile communications, a function of receiving and sending digital information such as text messages is added to a mobile station chiefly used for voice calls. Hence, the keypad provided on the mobile station for the entry of a telephone number additionally has a function of entering characters, thus reducing the size of the keypad used as an input means in the mobile station and hence limiting the number of buttons included on the keypad. Alphabets of every language are usually much more than 12 keys on the keypad. Therefore a need exists to represent every character with buttons on a telephone keypad alone or in combination of two or more different types.

### SUMMARY OF THE INVENTION

The invention disclosed in the prior documents published by the present applicant (i.e., Application No. 10-2000-0031879 and PCT/KR00/00601) can be summarized as follows.

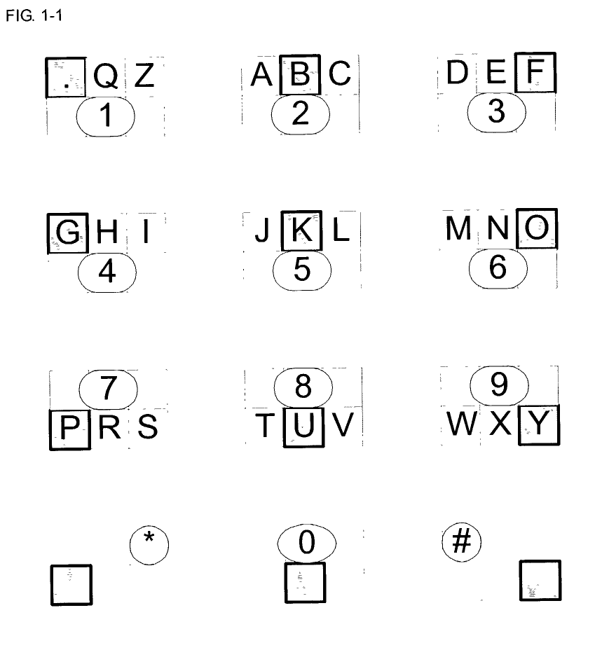

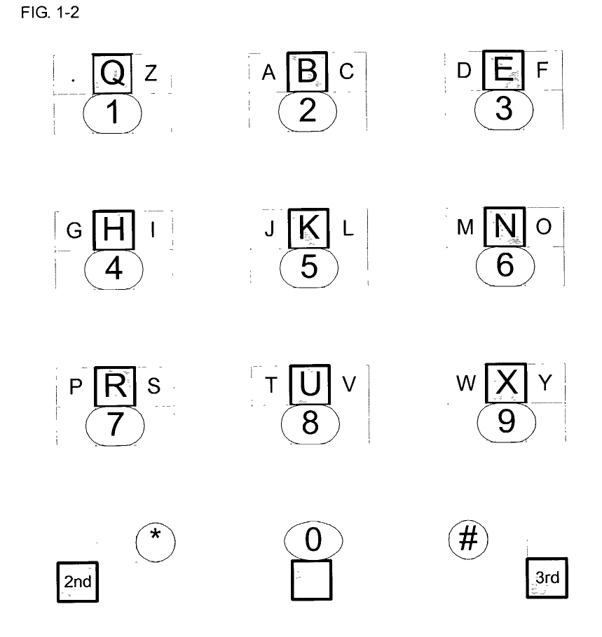

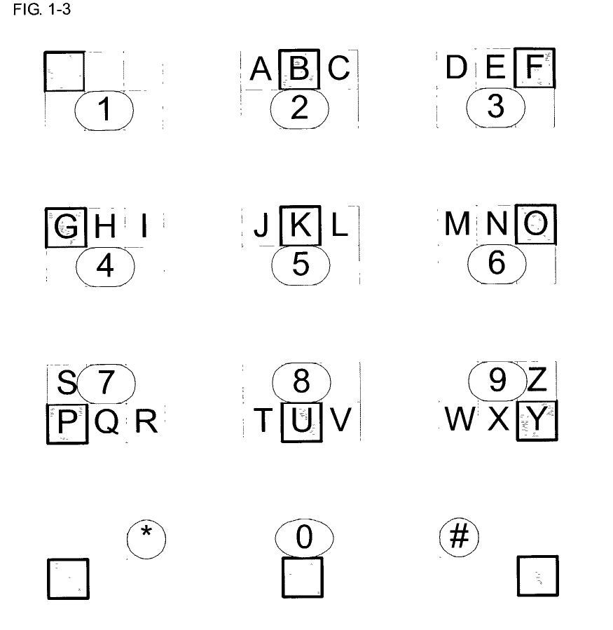

First, so-called “Part-Whole Selection Method (PWSM)” assigns characters to a given number of lattices provided to every button on the keypad in correspondence to the arrangement of buttons on the keypad, so that the user can enter a desired character (hereinafter, referred to as “target character”) by pressing a first button for the target character in combination with a second button provided on the keypad in correspondence to the arranged position of the character in the lattices of the first button. For example, the user may enter “A=[1]+[2]” in FIG. 1-1.

The core of PWSM is using part of the lattice elements of every button including a base lattice element (BLE), for which the first button is identical to the second one, and particularly, in the Order of Proximity to a BLE that is most convenient in button combination. As such, the base lattice element forms the core of PWSM and a keypad making the use of the conception of the Base Lattice Element is called “Base Keypad (BK)”.

Next, so-called “Base Repeat Selection Method (BRSM)” enables the user to select an character depending on the number of times of pressing a button on a Base Keypad designed to use PWSM in the order of proximity to a BLE, i.e., the Convenient Order of Button Combination (COBC) in PWSM. BRSM makes the user of a Repeat Selection Method (RSM) on the Base Keypad. Expediently, a keypad using only RSM is called “Plain Keypad (PK)”, and a method of using RSM in a PK as is usual is referred to as “Simple Repeat Selection Method (SRSM)”.

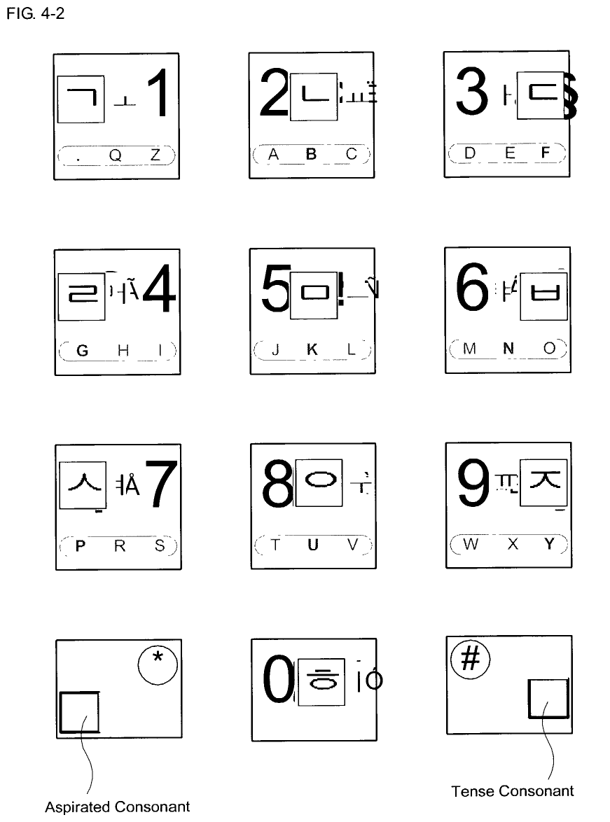

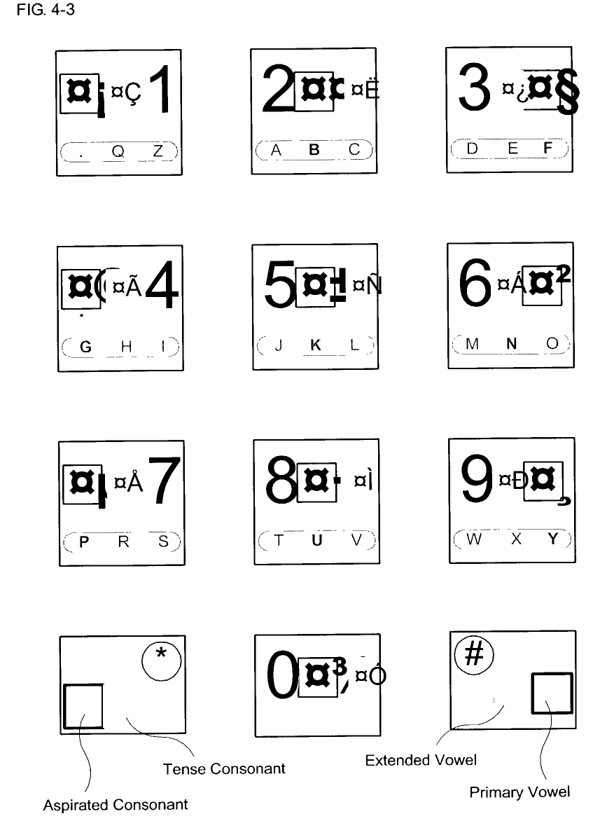

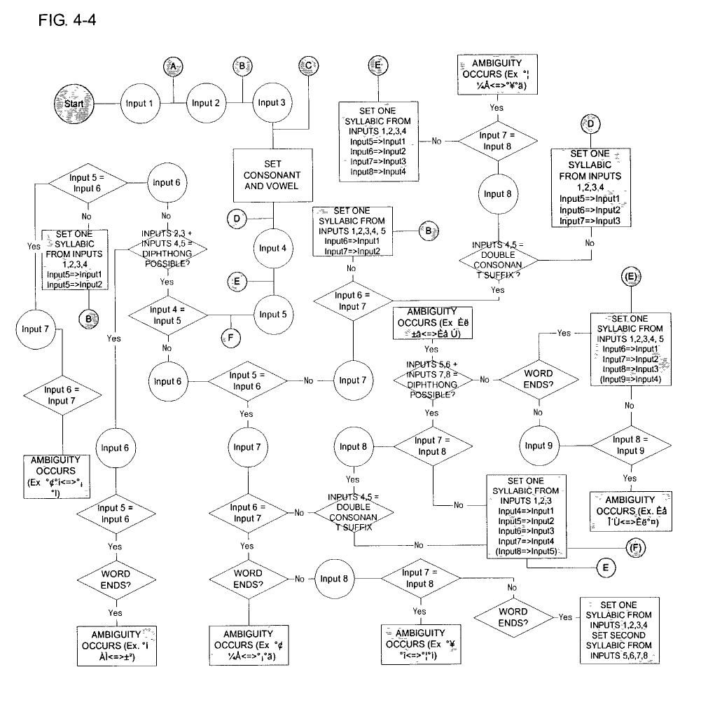

There is also a “Control Processing Method (CPM)”, which includes an “Affix Control Processing Method (ACPM)” and a “Succession Control Processing Method (SCPM)”. The affix control processing method is to enter affixed characters by a combination of affix control and basic character. The succession control processing method defines a group of characters assigned to a button as the relation among a representative character and its succession characters, and compounds the representative character and the priority associated with the representative character. For example, the user may enter as “ [symbol] = [symbol] +[*]” in FIG. 4-1.

The Affix Control Processing Method (ACPM) is in substance similar to the Succession Character Control Processing (SCPM). The latter is more general than the former, because a specific character group also includes affixed characters belonging to basic characters in a defined sequent order in SCPM. The ACPM has a close connection with the character group in shape because affixed characters are decomposed into an affix and a basic character, while SCPM is closely connected to sequent order and pronunciation.

The CPM are advantageous in that succession (or affixed) characters are not displayed on the keypad through the relation between a basic character and its succession (or affixed) characters to provide a simple arrangement of the keypad and enter character without ambiguity. A keypad that excludes succession characters is called “Succession Keypad (SK)” and one excluding affixed characters is called “Abbreviated Keypad (AK)”. Both SK and AK are referred to as “Concise Keypad (CK)”. A keypad that displays all succession (or affixed) characters in contrast to CK is called “full keypad (FK)”.

The full keypad also enables the entry of succession (or affixed) characters using CPM, while CK allows the user who memorizes the arrangement of the full keypad to perform the entry procedure on the full keypad. As described above, CK can be expanded to the FK and the user can expediently enter succession characters by CPM, which guarantees compatibility characteristic of the prior document.

The control processing method not only removes ambiguity but also simplifies the arrangement of the keypad by “hiding” the succession characters via the relation between a representative character and its succession characters as described in the prior documents. Expediently, this is called “Hiding Control Processing Method (HCPM)”. The succession (or affixed) characters may be input by CPM even on the full keypad on which the succession (or affixed) characters are displayed, as described in the prior documents. Expediently, this is called “Non-hiding Control Processing Method (NCPM)”.

The present invention suggests the improvement of the prior documents of the applicant (Application No. 10-2000-0031879 and PCT/KR00/00601). More particularly, it provides (a) a method for entering commonly used words with a small number of strokes, (b) a method for entering all target characters using a concurrent input method (CIM) that involves both a short-cut input method (SIM) and a full input method (FIM), to reduce input strokes and thereby enhance the convenience in entering characters, (c) a method for entering various symbols on a keypad, and (d) a method for using a move button, not frequently used in the character input mode, as a control button.

### BRIEF DESCRIPTION OF THE DRAWINGS

FIG.

### DETAILED DESCRIPTION OF THE PREFERRED EMBODIMENTS

Hereinafter, the present invention will be described in detail by way of the following examples, which are not intended to limit the scope of the invention.

First, the content of the prior documents will be explained by language as follows. It is apparent that although not specifically described, the content of the prior documents related to a certain language is also applicable to other languages.

1. Common Supplementary Explanation

1.1. Applications of Keypad in Prior Documents and Present Invention

It is apparent that the keypad proposed in the prior documents and the present invention can be used in all applications that have the form of a telephone keypad, including a numeral keypad of mobile terminals or standard keyboards, a keypad implemented on a screen in software, or a door lock. Although the numeral keypad of the standard keyboards differs in the arrangement of numeral buttons from the keypad of the prior documents and the present invention, the arrangement of the buttons on the keypad of the prior documents and the present invention may be applicable to the keypad of the keyboards. For example, the character assigned to a button [1] in the prior documents and the present invention is set to the button [1] on the numeral keypad of a keyboard, et cetera, which method is applicable to the entry of a character, the use of simple codes and memorization of various codes.

1.2. Determination of Successive Stroke Delay Time (SSDT) and Discrete Stroke Delay Time (DSDT)

For some languages such as Korean and Hindi in which consonants and vowels alternately appear, a pair of a representative consonant and a vowel is assigned to each button such that the consonant is input with one stroke and the vowel is input with two strokes. An algorithm may be implemented to first recognize two strokes of a button given at a predetermined delay time (for example, 0.1 second) interval as a vowel and enable the user to efficiently enter the vowel easily. The delay time has to be determined in consideration of the time interval commonly spent for a stroke in successively pressing the same button. Expediently, such a delay time is called “Successive Stroke Delay Time (SSDT)”. Also, an algorithm may be implemented to first recognize two strokes of a button given at a predetermined delay time (for example, 1 second) interval as two consonants. Expediently, such a delay time is called “Discrete Stroke Delay Time (DSDT)”. This may also be applicable to three or more strokes of the same button.

For instance, if the user presses the button [1] twice with a delay time of 0.08 seconds as in FIG. 4-1 or 4-2, the two strokes are first recognized as a vowel, i.e., “ [symbol] ”, and if with a delay time of 1.1 second, the two strokes are first recognized as two consonants, i.e., “ [symbol] ” and “ [symbol] ”. If the delay time is 0.5 seconds, it is possible to determine whether the user intended to enter one vowel or two consonants, from the structure of the corresponding language showing the way that consonants and vowels appear in the language. Even if the delay time of two storkes is 0.08 or 1.1 seconds, whether to recognize the two strokes as one vowel or two consonants can be determined finally from the structure of the language showing the way that consonants and vowels appear in that language.

Conventionally, the time interval is fixed (for example, as 1 second) so as to recognize successively pressing a button twice within the corresponding time as two successive strokes and successively pressing a button twice at a time longer than the corresponding time as two discrete strokes. There is a difference in the reference time delay value between recognition of two successive strokes (for example, 0.1 second) and recognition of two discrete strokes (for example, 1 second).

Typically, RSM is preferable to PWSM in the prior documents in the aspect of convenience of entry. Therefore, this method having the advantages of RSM (i.e., simplicity of input rules and convenience) uses the structure of a specific language where consonants and vowels appear alternately, to avoid ambiguity and to simplify the implementation of an algorithm in such a manner that SSDT is different from DSDT and the user is allowed to designate SSDT and DSDT.

1.3 Chain Type Control Processing Method

According to the prior document, ACPM is substantially similar to SCPM and the latter is more general. That is, the prior documents describe, in an example of the Korean alphabet, the relationship among [symbol] , [symbol] and [symbol] as the relationship among a representative character and its affixed characters, i.e., [symbol] = [symbol] +{aspirated consonant} and [symbol] = [symbol] +{tense consonant}. But, the same results are achieved in the present invention by way of the relationship between a representative character and its succession characters as [symbol] (representative character), [symbol] (2nd) and [symbol] (3rd).

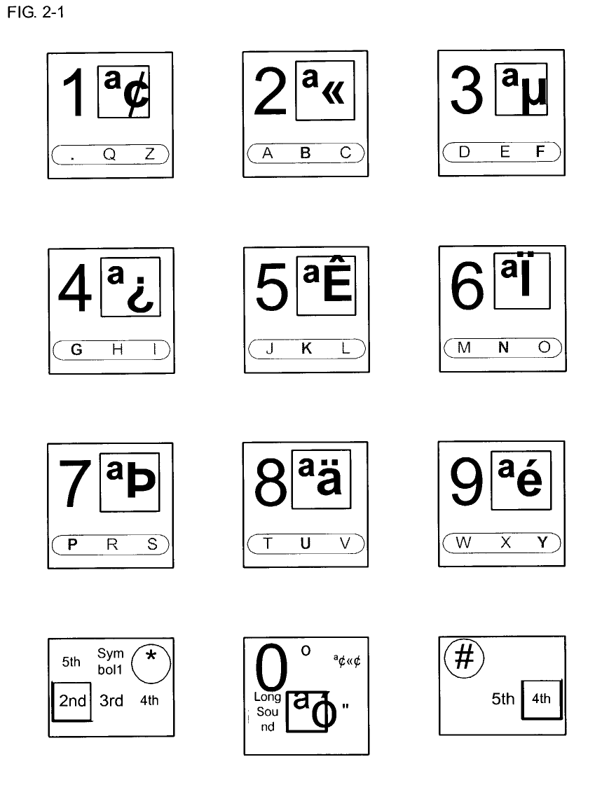

For the Japanese language of FIG. 2-1, an example of the entry using SCPM may be described as follows. With the relationship among a representative character and its succession characters such as [symbol] (representative character), [symbol] (2nd), [symbol] (3rd), [symbol] (4th) and [symbol] (5th), [symbol] is selected with one stroke of the button [1] ( [symbol] =[1]), and the 2nd to 5th controls are assigned to a control button (for example, [*]) and repeatedly selected according to the number of times of pressing the control button to enter the succession characters by combining the representative character and its succession controls. Expediently, selection of the control is transcribed in braces. When a control is set to be selected after the input of a basic character, entries are given as [symbol] =[1], [symbol] = [symbol] +{2nd}=[1]+[*], [symbol] = [symbol] +{3rd}=[1]+[*]+[*], [symbol] = [symbol] +{4th}=[1]+[*]+[*]+[*], and [symbol] = [symbol] +{5th}=[1]+[*]+[*]+[*]+[*].

Again, the relationship is established among a representative character and its succession characters such as [symbol] (representative character), [symbol] (2nd), [symbol] (3rd), [symbol] (4th) and [symbol] (5th). Instead of assigning the succession control to the control button and applying RSM, the “succession” or “next” control is selected by one stroke of a specific control button (for example, [*]). A second succession character (for example, [symbol] ) is input with a combination of a representative character and “next control”, and a third succession character (for example, [symbol] ) is input with the previous character (the second succession character) as a second representative character and “next control”. That is, [symbol] = [symbol] +{next}=[1]+[*]+[*]. Likewise, a fourth succession character [symbol] is input with a combination of the previous character (the third succession character) as a third representative character and “next control”. That is, [symbol] = [symbol] +{next}=[1]+[*]+[*]+[*]. The fifth succession character is also input in the similar way.

This result is the same as that obtained when succession control (2nd, 3rd, 4th, 5th, . . . ) is assigned to the control button as selected by RSM and the entry is given by a combination of a representative character and the succession control. It is seen that entry of the first representative character [symbol] without ambiguity results in successful entry of the second succession character [symbol] without any ambiguity, et cetera. That is, [symbol] = [symbol] +{next}=[1]+[*]+[*], which makes it possible to enter [symbol] without ambiguity. Thus the subsequence character [symbol] can also be input without ambiguity because [symbol] is combined with the “next control”.

Expediently, such a method is called “Chain type Succession Control Processing Method (Chain type SCPM)” in which with the “next” control but the succession controls assigned to the control button, the succession character is entered by a combination of the previous character regarded as a new representative character and the “next” control. The prior documents describe that the user has only to recognize a specific button as a succession control button even if the succession control is not marked on the succession control button. The chain type SCPM is advantageous in that the representation of “next control” on the control button is simplified. The present invention uses the “succession control processing method (SCPM)” in combination with the “chain type SCPM”, because the former has the same result as the latter as described in the prior document.

1.4 Jump Control Processing Method (JCPM)

In ACPM, a affixed character ë comprising “..” and “e” can be entered by a combination of .. and e. Alternatively, e is designated as a basic character and its succession characters related to the basic character in regard to shape and priority are assigned as succession characters, such that the affixed character ë can be entered by a combination of the basic character and the adjunctive priority (for example, e (basic character), é (2nd), ê (3rd), . . . ). Also, an affixed or succession character can be entered without ambiguity by the repeated press of the control button to which controls that become meaning only in combination with an character (i.e., a specific numeral button) are assigned.

For Roman alphabet, use is made of 11 affixed characters in the French language including é, ê, è, ë, à, â, î, ù, ü, ç, and ô. There are five types of the affix used in the affixed characters, such as /, \hat{ }, `, . . . , and s. If the affix control is selected in the order of /, \hat{ }, `, . . . , and s, the entry has to be given as â=a+[*]+[*]. However, affix “/” cannot be attached to character “a” because there are only two combinations for character “a” with affix “`” or “\hat{ }” in the French language. Thus affix “/” is skipped (i.e., jumped) and affix “\hat{ }” can be selected to given an entry as â=a+[*]. Expediently, this system is called “Jump Control Processing Method (JCPM)”. That is, the JCPM designates the adjunctive priority of a succession character as a (basic character), à (2nd) and à (3rd) to enter a succession (or affixed) character in the same manner as control processing method.

Likewise, in Japanese, a long sound exists in the character [symbol] among the characters on the rows of [symbol] , [symbol] and [symbol] , and a voiced sound is present in the characters on the rows of [symbol] , [symbol] , [symbol] , and [symbol] , the semi-voiced sound being present in the characters on the [symbol] row. As a result, the character [symbol] has two affixed characters, i.e., a long sound and a voiced sound, and characters on the [symbol] row have two affixed characters, i.e., a voiced sound and an semi-voiced sound. Thus only one stroke of an affix control button can be given in entering the affixed characters of the other characters other than the six that have two affixed characters. For example, when the control button is set to [*] and a control is set to be selected after the input of a basic character, entries are given as [symbol] = [symbol] +[*] and [symbol] = [symbol] +[*]. For the six characters each having two affixed characters, the affixed characters are entered with the control selected in the order of use frequency of the affixed characters. For example, when the control button is set to [*] and a control is set to be selected after the input of a basic character, entries are given as [symbol] = [symbol] +[*], [symbol] = [symbol] +[*]+[*], [symbol] = [symbol] +[*] and [symbol] = [symbol] +[*]+[*]. That is, the control is selected in such a manner that the control incapable of being combined with the basic character has no effect. For instance, [*] in the entry given as [symbol] = [symbol] +[*] is not a long sound control but a voiced sound control, because the basic character [symbol] has no long sound and must be combined with the voiced sound control.

A strict selection of control is advantageous in entering characters not used in practice. It is possible to enter, for example, an imaginary character of the French language comprising b and affix “..”, and one of the Japanese character comprising [symbol] and a voiced sound point.

Even though the control is selected by the repeat selection method (RSM), it is possible to enter the other succession characters without ambiguity only if a representative character marked on a keypad can be input without ambiguity via control processing (for example, when there is only 1 representative character on 1 button, or using a character input method without any ambiguity such as the part-whole selection method (PWSM) even when characters are located on each button). The reason for this lies in that the ambiguity is eliminated via control processing because the control, not alone but in combination with another character, can represent a specific character.

1.5 Input of Numerals and English Alphabet by Control Processing Method

The prior documents describe that mother language, numerals and then English alphabet are arranged “in the order of proximity to a BLE” and selected in the same manner by BRSM. Likewise, numerals and English alphabet (excepting Roman alphabet) as well as mother language can be input by SCPM.

Numerals or English alphabet may be assigned subsequent to the mother language succession characters. Japanese characters, for example, are assigned in the order of [symbol] (representative character), [symbol] (2nd), [symbol] (3rd), [symbol] (4th), [symbol] (5th), 1 (6th), . (7th), q (8th), z (9th), and so forth. If control buttons for numerals or English alphabet are available, a control button for [symbol] (representative character), [symbol] (2nd), [symbol] (3rd), [symbol] (4th) and [symbol] (5th) is assigned to a certain button (for example, [*]) and a control button for numerals or English alphabet is assigned to a second button (for example, [#]), so that numerals and English alphabet are input as [symbol] (representative character), 1 (2nd), . (3rd), q (4th) and z (5th). For example, entries are given as 1= [symbol] +[#]=[1]+[#], .= [symbol] +[#]+[#]=[1]+[#]+[#] and q= [symbol] +[#]+[#]+[#]=[1]+[#]+[#]+[#]. If available, control buttons for numerals and English alphabet are separately provided.

This may be applicable to the entry of other languages and various symbols that will be described later.

1.6 Pronunciation-Based Grouping of English Alphabet Characters

The prior documents construct a keypad for each language in such a manner that characters are grouped by similar pronunciation and assigned to each numeral button in consideration of using CPM and the use purpose for memorization of codes. As for English, a widely used method groups three or four characters in a dictionary order and assigns the character groups to each numeral button. Likewise, it is also possible to group characters in consideration of the similarity of pronunciation and assign the character groups to each numeral button. For example, the consonants of English alphabet fall into nine groups according to the similarity of pronunciation as follows:

B P / C S X / D T / F V H / G K Q / J Z / L R / M N / W Y
B P V / C S X / D T / F H / G K Q / J Z / L R / M W / N Y

Alternatively, the consonants of English alphabet fall into eight groups as follows:

B F P V / C G K Q / S X / D T / J Z / L R / M W H / N Y
B F P V / C G K Q / S X / D T / J Z / L R / M N / W Y H

Besides the above two examples, other variations are possible. Five vowels are properly set in the groups of two consonants. This guarantees convenience in applying Short-cut Input Method (SIM) using simple codes, which will be described later. For non-English languages, the above-constructed character groups can be assigned to each button in consideration of the similarity of pronunciation between the mother language and English. For Korean, for example, a group of G, K and Q is assigned to a button for character “ [symbol] ” which is similar in pronunciation to G, K and Q. As for Japanese, a group of G, K and Q is assigned to a button for character “ [symbol] ” which is similar in pronunciation to G, K and Q. Therefore, English alphabet can be grouped considering the grouping pattern of every mother language.

2. Language-Based Supplementary Explanation

Hereinafter, a supplementary explanation and improvements will be given as to the content of the prior documents by language as follows. It is apparent that although not specifically described, the content of the prior documents related to a certain language is also applicable to other languages.

2.1 English

As described in the prior documents that succession characters are input on a full keypad using CPM, it is also possible to enter English alphabet, other than representative characters, marked on the keypad. The succession controls, i.e., 2^{nd} and 3^{rd} controls are assigned to the same control button (for example, button [#]) or to different buttons (for example, buttons [*] and [#]). It is assumed that English alphabet, for example, A, B and C are assigned to a common control button. If the representative character is A, the succession characters B and C are independently entered via succession control processing. Otherwise, if the representative character is B, the succession characters A and C are independently entered via SCPM. The representative character and the adjunctive priority of the succession characters are defined in consideration of the use frequency as described in the prior documents.

For example, when A is the representative character in a group of A, B and C, and control after input representative character applies with 2^{nd} and 3^{rd} controls assigned to a button [*], entries are given as B=A+{2^{nd}}=[2]+[*] and C=A+{3^{rd}}=[2]+[*]+[*]. If B is the representative character and control after input representative character applies, with 2nd and 3rd controls assigned to buttons [*] and [#], respectively, entries are given as A=B+{2^{nd}}=[2]+[*] and C=B+{3^{rd}}=[2]+[#]. FIG. 1-2 shows an exemplary arrangement of a keypad designed to easily discriminate the characters, in which the middle character in each group of characters is designated as the representative character and the succession characters are each disposed on the right and left sides of the representative character. For example, D=E+{2^{nd}}=[3]+[*].

In the case where four characters of P, Q, R and S are assigned to a button [7], four characters of W, X, Y and Z being assigned to a button [9], as pointed out in the example of the prior document concerning Korean, PWSM may be adapted in such a manner that one of the four characters can be assigned to a lattice element that forms Vertical Adjacent Combination (VAC). Reference is made to FIG. 1-3.

2.2 Japanese

The prior document described that the Japanese characters are grouped with reference to the Japanese 50-sound table and subjected to the succession control processing using the characters on the [symbol] column, i.e., [symbol] , [symbol] , [symbol] , etc. as representative characters and the others as the succession characters. The adjunctive priority of the succession characters is determined with reference to the Japanese 50-sound table presented in the following table in the almost same manner as the approach 3 of the prior document. This makes the user much familiar to the grouping method due to simplicity of the adjunctive priority. [symbol] may be regarded as belonging to a representative character as described in the prior document. Alternatively, characters of the 50-sound table (for example, [symbol] , [symbol] or [symbol] ) or [symbol] is regarded as belonging to the blank on the row of [symbol] or [symbol] .

| Method 3 of Prior Document | | | | | Simple Use of 50-Sound Table | | | | |
|---|---|---|---|---|---|---|---|---|---|
| Base | | | | | Base | | | | |
| Lattice | | | | | Lattice | | | | |
| Element | 2nd | 3rd | 4th | 5th | Element | 2nd | 3rd | 4th | 5th |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | | | [symbol] | | [symbol] | | [symbol] |
| [symbol] | [symbol] | [symbol] | [symbol] | [symbol] | [symbol] | [symbol] | [symbol] | [symbol] | [symbol] |
| [symbol] | [symbol] | [symbol] | | | [symbol] | | | | [symbol] |

Although the prior document describes that characters on the first cloumn are expediently designated as representative characters, the representative characters can be characters on any column or any character belonging to each group. characters on each row may be assigned to each button based on a row of buttons on the keypad (i.e., [1], [2], [3], [4], . . . ) as described in the prior document, or based on the column of buttons (i.e., [3], [6], [9], [2], [5], . . . ). Alternatively, assignment of the characters to each button may be achieved arbitrarily not based neither row nor column.

The prior document describes in the example of Japanese that when “ [symbol] ” is arranged at the position of the base lattice element of the button [0], with 2nd and 3rd controls and 4th and 5th controls assigned to the buttons [*] and [#], respectively, “ [symbol] ” is assigned to a numeral button but the button [0] in order to use the button [0] as a control button for entering a long/voiced/semi-voiced sound. Instead, “ [symbol] ” is arranged at the position of the base lattice element of the button [0], with control buttons for a long/voiced/semi-voiced sound being additionally arranged in the Order of Proximity to a BLE (OPBLE). Then RSM may be adapted to control selection, because there is no case where “ [symbol] ” does not consecutively appear in a word. Reference is made to FIG. 2-1. Such a method of selecting an character, not appearing in succession in a word, with one stroke of the corresponding button and other controls with two, three or more strokes of the button may be applicable to all other languages. This feature is also used in the method using the vowel element of Korean that will be described later.

2.3 Arabic

There are 28 consonants in the Arabian language. According to the prior document, the consonants of Arabic representing numerals are grouped and assigned to each button on the keypad, and the character representing the smallest numeral is designated as a representative character and arranged at the position of the base lattice element, the other characters being assigned to the buttons on the keypad in the Order of Proximity to a BLE (OPBLE). The prior document provides a method for entering characters of the Roman, Korean, Hindi and Arabic languages by way of control processing. It also provides a method for entering characters of Arabic in which rarely used vowels are regarded as a affix and subjected to the affix control processing.

Now, a description will be given as to a method for control processing (i.e., succession control processing) the consonants of Arabic. The table below shows an exemplary arrangement of the consonants of Arabic to each button.

| Button | [1] | [2] | [3] | [4] | [5] | [6] | [7] | [8] | [9] | [0] | |
|---|---|---|---|---|---|---|---|---|---|---|---|
| Meaning | 1 | 2 | 3 | 4 | 5 | 6 | 7 | 8 | 9 | 1000 | |
| Base Lattice | [symbol] | [symbol] | [symbol] | [symbol] | [symbol] | [symbol] | [symbol] | [symbol] | [symbol] | [symbol] | 1-Unit |
| Element | | | | | | | | | | | Character |
| Meaning | 10 | 20 | 30 | 40 | 50 | 60 | 70 | 80 | 90 | | |
| 2^{nd} | [symbol] | [symbol] | [symbol] | [symbol] | [symbol] | [symbol] | [symbol] | [symbol] | [symbol] | | 10-Unit |
| | | | | | | | | | | | Character |
| Meaning | 100 | 200 | 300 | 400 | 500 | 600 | 700 | 800 | 900 | | |
| 3^{rd} | [symbol] | [symbol] | [symbol] | [symbol] | [symbol] | [symbol] | [symbol] | [symbol] | [symbol] | | 100-Unit |
| | | | | | | | | | | | Character |
| Meaning | 1000 | | | | | | | | | | |
| 4th | [symbol] | | | | | | | | | | 1000-Unit |
| | | | | | | | | | | | Character |
| | Group 1 | Group 2 | Group 3 | Group 4 | Group 5 | Group 6 | Group 7 | Group 8 | Group 9 | Group 10 | |
| | character | character | character | character | character | character | character | character | character | character | |

Among the characters representing 1, 10 and 100 assigned to the button [1], the character representing 1 is designated as the representative character and the others representing 10 or 100 are subjected to the succession control processing. Any button may be designated as a control button, as described in the prior document. If the succession control button is assigned to the button [*], with 2^{nd} and 3^{rd} controls arranged, consonants are entered with two strokes on the average. It is unnecessary to select characters marked on the button by PWSM, because only one character is assigned to each button. The arrangement of characters is notional and hence characters may not be allocated to the keypad as described later.

According to the prior document, succession control may be separated as another button as in the case of Japanese. For example, when the 3^{rd} control is assigned to the button [#], the average number of input strokes is about 1.7 (=(1+2+2)/3) and 28 consonants can be entered without ambiguity as described in the prior document.

The present invention designates an character representing the smallest numeral as a representative character of each group and selects an character representing the smaller numeral among the succession characters of the other units, irrelevant to the use frequency. A control can be set to be selected after of before the input of a representative character.

If succession controls are all assigned to the button [*], with the 1-unit character designated as a representative character, and the control is selected before the entry of the representative character, entries of the 10-unit characters are given as [symbol] =[*]+ [symbol] and [symbol] =[*]+[*]+ [symbol] . The same procedures are performed for the other characters. In this case, the button [#] may be used for the vowel control processing.

If control before input representative character applies with only one character representing 1000 being assigned to the button [0], the entry of [symbol] is given as [symbol] =[0]. The character representing 1000 may be processed as those belonging to the first group, in which case the entry is given as [symbol] =[*]+[*]+[*]+. Alternatively, since the character representing 100 has such a form in which an upper point is added to the character representing 70, i.e., [symbol] the upper point control can be selected prior to various vowel controls in the control processing. That is, if control before input character is applied to the upper point control, the entry is given as [symbol] ={upper point control}+ [symbol] . Another character comprising an upper point can also be entered using the ACPM and another input method simultaneously. In this case, it becomes easy to use the button [0] as a control button for another use purpose (for example, vowel control button).

If the 3^{rd} control (i.e., 100-unit control) is separately assigned to the button [#], the entry of the character representing 200 is given as [symbol] =[#]+ [symbol] . Alternatively, the entry of [symbol] is given as [symbol] =[*]+[*]+ [symbol] as in the case of Japanese according to the prior document. If the character representing 1000 belongs to the first group of characters and control before input character applies, the entry is given as [symbol] =[*]+[*]+[*]+ [symbol] or [symbol] =[#]+[#]+ [symbol] . That is, the 2^{nd}, 3^{rd} and 4^{th} controls are assigned to the button [*], the 3^{rd} and 4^{th} controls being assigned to the button [#]. Considering that the Arabians writes from left to right, it is also possible to assign the 2^{nd}, 3^{rd} and 4^{th} controls to the button [#] and the 3^{rd} and 4^{th} controls to the button [*].

This means that the frequently used characters, i.e., consonants of Arabic can be entered with about 1.7 strokes on the average without ambiguity. Advantageously, characters (for example, 1-unit characters, i.e., representative characters) not marked on the keypad can be readily selected, because the Arabians know the numerical meanings of their mother language. That is, the present invention is applicable to a keypad marking only numerals in entering almost characters (consonants of Arabic) necessary in the daily life, only if the user has the knowledge of the regulations concerning the unit character designated as a given representative character or assigned to a given control button, the sequent order of the succession controls, if assigned to a single control button, or whether the control is set to be selected before representative characters.

It is possible to perform a control processing of vowels, as described in the prior document. When using both the button [#] and the button [*] for consonant control processing, the character representing 1000 is not assigned to the button [0] but the button [1] to designate the button [0] as a vowel control button and input vowels as affix (i.e., vowel control or affix control) by way of RSM, as described in the case of Japanese according to the prior document. This method selects the vowel control (vowel as affix) based on the number of times of pressing the button in the order of use frequency. If using only one button [*] as a succession control button for consonants, the control button for vowels may be the button [#], or both the button [#] and the button [0].

Although the characters representing 1 to 9 (1-unit characters) are designated as the representative characters of each group in the examples of FIGS. 3-1 and 3-2, characters having the highest use frequency in each group may be the representative characters. To avoid confusion, the representative characters can be any unit characters among 1-unit characters (characters representing 1 to 9), 10-unit characters (characters representing 10 to 90), and 100-unit characters (characters representing 100 to 900).

Likewise, the characters selected by the succession control may be each unit character based on the use frequency. For example, if 100-unit characters having the highest use frequency are designated as the representative characters and 1-unit characters is second to the 100-unit characters in the use frequency, it is possible to enter the 100-unit characters with a combination of the 2^{nd} control (i.e., 1-unit control) and the representative characters, and the 10-unit characters with a combination of the 3rd control (i.e., 10-unit control) and the representative characters.

As the prior document describes that the succession characters can be entered by CPM, it is possible to enter consonants by SCPM and vowels by ACPM on the keypad of the prior document. If the button [0] is designated as the affix control button for vowels in the 3*4 keypad, the control buttons for entry of consonants may be both the button [*] and the button [#].

2.4 Korean

2.4.1 Separation of Aspirated Consonant and Tense Consonant Controls

The prior document describes, with reference to FIG. 4-1, that the aspirated consonant control is assigned to the button [*] and arranged at the position of the base lattice element, the tense consonant control being arranged to the lattice element secondly close to the base lattice element, so as to select the aspirated consonant control with one stroke of the control button and the tense consonant control with two strokes of the control button. However, a time delay is naturally given between vowels in entering an extended vowel (i.e., two vowels) so that there is actually no ambiguity even through the extended vowel is not input by CPM. Likewise as described in the case of Japanese according to the prior document, the aspirated consonant control is additionally assigned to the button [#] and arranged at the position of the base lattice element so as to select the aspirated consonant control with one stroke of the button [#]. Reference is made to FIG. 4-2. If control is set to be selected before representative character, entries are given as [symbol] ={aspirated consonant}+ [symbol] =[*]+ [symbol] , and [symbol] ={tense consonant}+ [symbol] =[#]+ [symbol] .

2.4.2 Control Processing of Basic Vowels

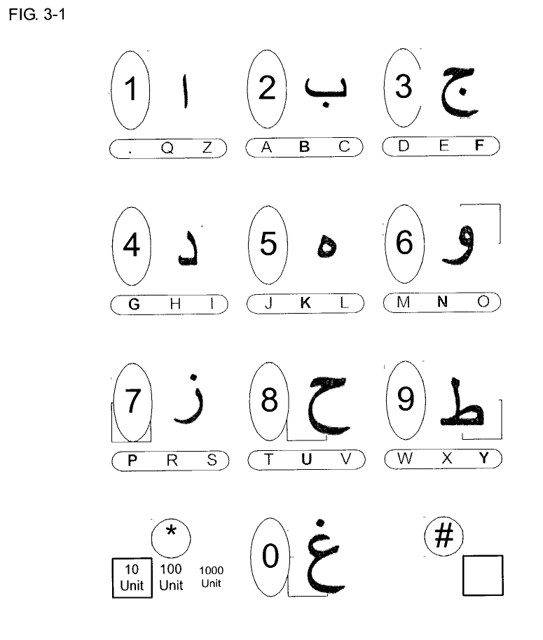

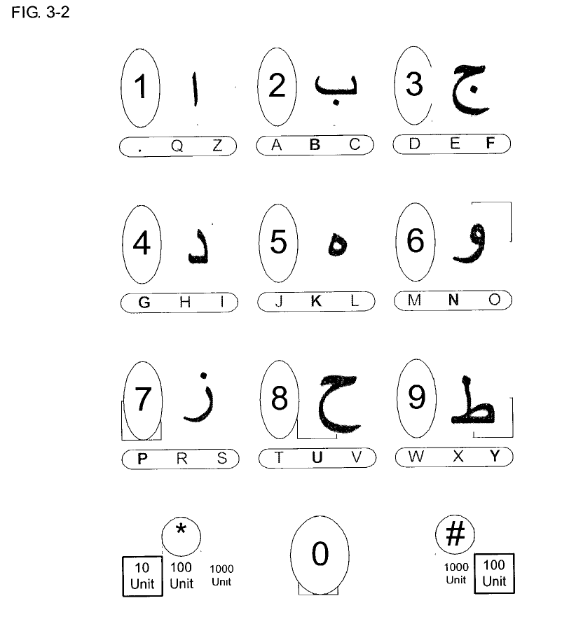

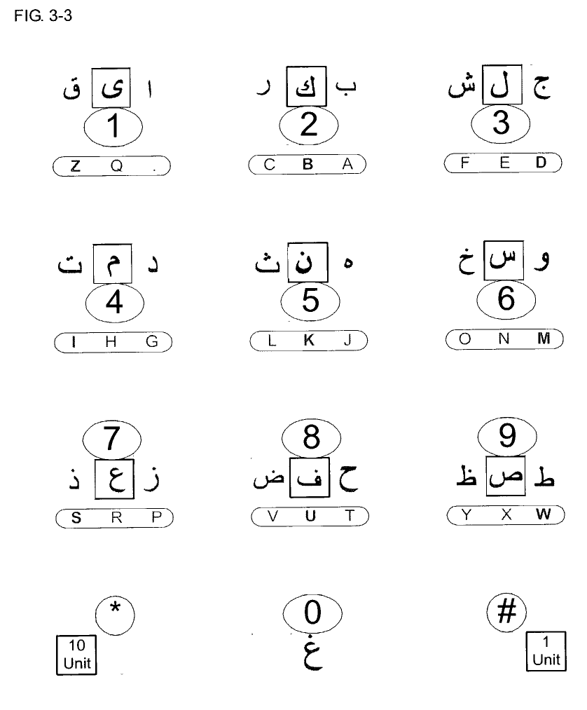

The prior document of the applicant (the prior document No. 10-2000-0025183) describes a method for using a pair of consonant and vowel, in which the button [#] is designated as the succession control button and the controls can be set to be selected before (or it is possible to be set to be selected after) the numeral buttons to enter a basic vowel in the same manner as described in the case of Japanese. This means that the basic vowel control is arranged as shown in FIG. 4-3 to enter the basic vowel by way of CPM without any ambiguity. As pointed out in the prior document, the basic vowels marked on the keypad can be input by the control processing likewise as Japanese (i.e., the entry of the succession character by the control processing on the full keypad).

This case is less convenient than the repeated selection of the basic vowel with two strokes of the corresponding button but eliminates the ambiguity completely. It is of course necessary to select the “basic vowel control” for entering the basic vowels with one stroke of the control button, because the basic vowels are used so frequently. FIG. 4-3 is an illustration in which the “basic vowel control” for control processing the basic vowels is added to the figure provided in the prior document. The basic vowel control is selected with one stroke of the control button, the extended vowel control being selected with two strokes of the control button. If control is set to be input after the representative character in the example of FIG. 4-3, entries are given as [symbol] =[3]+[#], [symbol] =[3]+[#]+[#], [symbol] =[4]+[#], and [symbol] =[4]+[#]+[#]. The same rules are applied to the cases of the other vowels and the extended vowels. The entries of similar extended vowels are given as [symbol] =[1]+[#], and [symbol] =[1]+[#]+[#].

Because there is no close connection between the representative consonants and the basic vowels, the basic vowels are marked on the keypad and entered by the non-hiding control processing method.

2.4.3 Common Use of Aspirated Consonant Control and Extended Vowel Control

It is possible to use one succession control button in entering both the subsequent consonants (i.e., succession consonants) and the subsequent vowels, as described in the case of Thai according to the prior document. For example, both the aspirated consonant control and the extended vowel control are arranged to the same lattice element of the control button. As described in the prior document, if the control button for processing the subsequent consonants is separated from that for processing the subsequent vowels, the pressing order (i.e., before or after representative character)of each control button can be designated differently

2.4.4 Programming

FIG. 4-4 is no more than a flow chart for realization of the invention, and more efficient programming is possible. For example, in the case of considering final consonant in FIG. 4-4, more efficient programming is possible by checking whether the consonants can form double final consonants.

The example of Korean suggested in the prior art may be applicable to other languages having a similar feature (i.e., a structure having consonants and vowels appearing alternately). For other languages, the feature of consonant and vowel appearance of the corresponding languages may be taken into consideration.

In the example of Korean, the first three strokes (inputs 1, 2 and 3) are always decided by the consonant and vowel of the first syllable (letter) from the “beginning of a word”. Of course, this is inapplicable to the case of Hindi in which a syllable comprising “vowel+consonant” appears first. Input 4 may be the final consonant of the first syllable (letter) or the first consonant of the second syllable (letter). Although all detailed procedures are not described in the flow chart of the prior document, it is determined whether input 4 is identical to the previous input (i.e., input 3). If so, it is possible to decide in advance that inputs 4 and 5 cannot form a double vowel, because inputs 4 and 5 should not be the same vowel in order to form a double vowel with the inputs 2 and 3 already decided. Otherwise, if input 4 is not identical to the previous input, input 4 is compared to the next input (input 5) in the subsequent procedure as shown in the flow chart.

If input 5 is identical to the previous input, it is checked whether inputs 4 and 5 can form a double vowel. Now, a description will be given to the case where inputs 4 and 5 cannot form a double vowel. If input 5 is not identical to the previous input, input 4 is decided as the final consonant of the first syllable (letter) and input 5 can be the double final consonant of the first syllable (letter) or the first consonant of the second syllable (letter). It is thus checked whether inputs 4 and 5 can form a double final consonants. If not, input 5 can be decided as the first consonant of the second syllable (letter). This is because among 196 (=14*14) combinations of 10 basic consonants and 4 aspirated consonants in Korean, no more than 11 combinations are possible, such as [symbol] , [symbol] , [symbol] , [symbol] , [symbol] , [symbol] , [symbol] , [symbol] , [symbol] , [symbol] and [symbol] . Once one syllable (letter) is decided, input 5 is regarded as input 1 in the next repeating procedure. If input 5 is identical to input 4 and cannot form a double vowel with inputs 2 and 3, input 4 may be decided as the final consonant of the first syllable (letter), input 5 being decided as the initial consonant of the second syllable (letter). Although not shown in the flow chart, this can be of course taken into consideration in programming the invention of the prior document.

The same procedures are performed as described in the flow chart when the double vowel can be formed. In all other cases causing ambiguity, if a word (or syllable (letter) with ambiguity has the one part terminating with a suffix (final consonant) and the other part terminating without final consonant (for example, “ [symbol] ”), it is checked whether the next input (expediently, referred to as “input x”) is “the end of the word”. If so, input x may be decided as the final consonant of the final syllable (letter) (for example, “ [symbol] +input x”).

2.4.5 Combination of Tense Consonant with Basic Consonant

The tense consonant can be processed with a combination of the basic consonants in all keypads of Korean as described in the prior document of the applicant. Expediently, reference will be given to FIG. 4-1.

If a tense consonant can be entered with a combination of two basic consonants, the procedures are performed in the same manner as described in the case where input 4 is not identical to input 5. Although convenience in entering characters may increase in this case, ambiguity occurs (for example, “ [symbol] ”) when a vowel terminates the first syllable without any consonant and the first consonant of the second syllable is an tense consonant. Even when a final consonant terminates the first syllable and the initial consonant of the second syllable is a tense consonant, the final consonant of the first syllable being the same as the initial consonant of the second syllable (for example, [symbol] ), the vowel of the first syllable and “the final consonant of the first syllable+the first consonant of the second syllable (for example, [symbol] + [symbol] ) are recognized as a double vowel (only in the case where “ [symbol] + [symbol] ”=“ [symbol] +[3]+[3]” forms a double vowel). As the feature of the invention of the prior document, ambiguity may occur more seriously because removal of the ambiguity by CPM in inputting tense consonant cannot be achieved.

The user may avoid ambiguity of “ [symbol] ” by providing a time delay or separately entering the syllables (i.e., using a means for deciding a syllable such as right arrow). Another example is given by “ [symbol] ”. In the latter case, there are 8 double vowels in Korean (in the case of two combinations except for three combinations of basic vowels), including [symbol] , [symbol] , [symbol] , [symbol] , [symbol] , [symbol] , [symbol] and [symbol] , which always terminate as [symbol] , [symbol] or [symbol] . If three of five consonants [symbol] , [symbol] , [symbol] , [symbol] and [symbol] , and three vowels [symbol] , [symbol] and [symbol] are grouped into pairs of consonant and vowel, ambiguity of “ [symbol] ” can be avoided even in entering the tense consonant with two basic consonants, thus correctly recognizing “ [symbol] ”.

It is possible in this case to recognize “ [symbol] ” correctly simply by grouping the characters instead of varying the existing algorithm (which checks whether the characters are allowed to form a double vowel). This prevents erroneous recognition of two successive strokes of the same button for entering a tense consonant as a vowel in the case where the first syllable (letter) has a final consonant and the next syllable (letter) begins with the tense consonant.

But, the flow chart of the prior document has to be revised in the case where a word begins with a tense consonant that is the first consonant of the first syllable word (i.e., inputs 1 and 2 is the first consonant as a tense consonant, inputs 3 and 4 is a vowel, that is consonant+vowel), which is apparent to those skilled in the art. In this case (where at the beginning of the word, inputs 1 and 2 are decided as a tense consonant, inputs 3 and 4 being decided as a vowel, i.e., “consonant+vowel”), when inputs 1 to 4 are all activated by selection of the same button, it may be confused with the case where input 1 is the first consonant as a basic consonant, inputs 2 and 3 being a vowel, input 4 being the final consonant (i.e., consonant+vowel+consonant). Such ambiguity can be avoided in some cases by checking whether the next input (expediently, referred to as “input x”) forms the final consonant of the “consonant+wowel” and the double final consonant of the “consonant+vowel+consonant” and terminates the word, and if input x cannot form a double final consonant and terminates the word, processing the input x as the final consonant of the “consonant+vowel”. Even in the case where input x forms a double final consonant, the same procedures are performed with the next input.

If a tense consonant is processed with a combination of two basic consonants, ambiguity may be regarded as caused by RSM. The ambiguity is avoidable through “index” that will be described later.

As a result, processing a tense consonant with a combination of two basic consonants may increase some ambiguity caused due to the use of RSM but enhances convenience and simplicity in entering characters.

Discrimination of words is achievable by any means of discriminating a word from another one, such as space, mode transition, move button, confirm, or termination of entry, etc.

2.5 Hindi

According to the prior document of the applicant, the consonants of Hindi are divided into 9 groups, which are assigned to buttons [1] to [9], and the vowels assigned to the button [0] are selected with one stroke of the button [0]. For consistency, in the present invention, consonants are divided into 10 groups so as to select the representative consonants with one stroke of the corresponding button and 10 vowels as two strokes of the button. A vowel _(ri) not allocated to the keypad and rarely used can be processed by CPM. Grouping of the consonants into 10 groups is achieved in consideration of the similarity of pronunciation as described in the prior document. An example of 10 groups of consonants is given as follows.

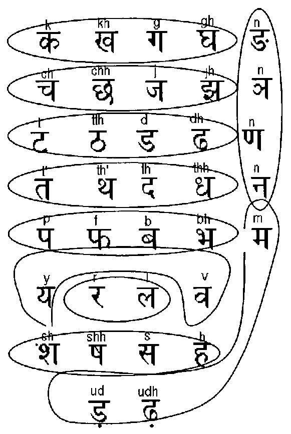

When the first vowel of Hindi, [symbol] (a) is located bewteen two consonants, it is omitted. That is, consonants appear in succession. It is very easy in this case to display “consonant+consonant” when “consonant+_(a)+consonant” is input. Of course, the entry may also be given as “consonant+consonant”, in which case the same representative consonant is input consecutively and the two consonants are erroneously recognized as one vowel. Both (automatic omission of the vowel _(a) or omission by the user) can be allowed.

2.6 Myanmar Language

There are 33 consonants in the Myanmar language. An example of 9 groups of the consonants is given as follows. Alternatively, the consonants may be divided into 10 groups in the similar manner.

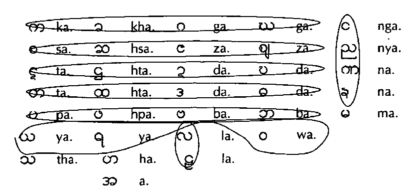

3. Minimization of Ambiguity via Mathematical Model in Using Pair of Basic Consonant and Basic Vowel

In the languages with consonants and vowels appearing repeatedly such as Korean, Hindi and Myanmar language, etc, 10 pears of basic consonant and basic vowel are assigned to the numeral buttons on the keypad and RSM is used to efficiently enter characters on the buttons with less ambiguity.

For Korean, tense consonants, aspirated consonants and extended vowels can be entered by CPM, i.e., a combination of control and basic character. For Hindi, the consonants adjunctive to the representative consonants are entered via the succession control processing. The present invention provides a method for minimizing the ambiguity in the invention of the prior document.

If assigning a plurality of characters to one button on the keypad and using RSM, ambiguity occurs as described in the prior document due to the inherency of RSM. For example, when entering “AB” allocated to the same button in succession as [2]+[2]+[2], there is a confusion in deciding whether the entry is “AB” or “BA”.

Expediently, in the case of Korean, almost syllables comprise “consonant+vowel (i.e., first consonant+medial vowel)” or “consonant+vowel+consonant (i.e., first consonant+medial vowel+final consonant)”. This rule is the similar to other languages such as Hindi and the Myanmar language. But, Korean is characterized in that one syllable forms one letter (i.e., one squared letter).

One of the main case of ambiguity occurrence is that the first syllable comprises “consonant+vowel” and the second syllable comprises “consonant+vowel+consonant”, and the “vowel+consonant” of the second syllable are assigned to the same button. In this case, the initial consonant of the second syllable can be recognized as the final consonant of the first syllable, and the “vowel+consonant” of the second syllable being recognized as “consonant+vowel”. To reduce the ambiguity, it is obvious not to assign the consonant and the vowel (i.e., “consonant+vowel”) in the syllable comprising “consonant+vowel+consonant” to the same button. That is, the vowel and the consonant, which are frequently transferred from vowel (medial vowel) to consonant (final consonant) in the syllable comprising “consonant+vowel+consonant”, should not be assigned to the same button. For Korean, such ambiguity occurs in some cases where the first syllable comprises “consonant+vowel+vowel” or the second syllable comprises “consonant+vowel+consonant+consonant”, but not many. More specifically, there are some cases where the coupling of vowel and consonant as well as the vowel-consonant transition frequency has to be taken into consideration for a Korean word in which the second syllable comprises “consonant+vowel+consonant+consonant”.

Judging from an opposite point of view, when the first syllable comprises “consonant+vowel+consonant” and the second syllable comprises “consonant+vowel”, and second syllable which are comprised of “consonant+vowel” are assigned to the same button, the first syllable can be recognized as “consonant+vowel”, the second syllable as “consonant+vowel+consonant” which is combined with the final consonant of the previous syllable. To minimize the ambiguity, consonant and vowel frequently combined together in the form of “consonant+vowel” in a syllable should not be assigned to the same button. There are some cases in Korean where the first syllable comprises “consonant+vowel+consonant+consonant”. Such cases are not quite common.

The prior document describes other cases that cause ambiguity but such cases are relatively rare in practice. Thus the present invention provides a method for minimizing ambiguity in two cases. This method is similarly applicable to any language such as Hindi and Myanmar, etc as well as Korean, in which consonant and vowel sequentially appear, and more particularly, to other languages where consonant and vowel appear in a simpler way than in Korean, so it is far easy to apply applicant's invention. FIG. 4-4 shows a flow chart (disclosed in the prior document) for discriminating characters when basic consonant and basic vowel of Korean allocated to the keypad are selected by RSM with reference to FIG. 4-1. The figure also shows the case where ambiguity occurs.

Hereinafter, the present invention will be described by way of the example of Korean.

Korean has about 50% (more precisely 54.011%) of syllables comprising “consonant+vowel” and about 50% of syllables comprising “consonant+vowel+consonant”. Therefore, it can be considered that the frequency of transition from consonant to vowel in a syllable comprising “consonant+vowel” (hereinafter, referred to as “consonant-vowel transition” or “consonant-vowel coupling”) is almost the same as that of transition from vowel to consonant in a syllable comprising “consonant+vowel+consonant” (hereinafter, referred to as “vowel-consonant transition” or “vowel-consonant coupling”). If Korean or other language has about 70% of syllables comprising “consonant+vowel” and about 30% of syllables comprising “consonant +vowel+consonant”, it should be considered that consonant-vowel transition is weighted about 30% (because ambiguity caused by the assignment of consonant and vowel to the same button occurs on the premise of the 30% cases that the previous syllable terminates as “consonant+vowel+consonant”) and that vowel-consonant transition is weighted about 70% (because ambiguity caused by the assignment of vowel and consonant to the same button occurs on the premise of the 70% cases that the previous syllable terminates as “consonant+vowel”).

The frequency of vowel-consonant transition is disclosed in the document as follows. 567 cases of vowel-consonant transition occur with 21 vowels (medium) and 27 consonants (final consonants) in Korean, and actually 270 cases of vowel-consonant transition take place. The utmost 12 cases make up 51% and the upper 48 cases form 90%. Such a large difference in the coupling frequency allows a great reduction of ambiguity via optimized grouping of consonant and vowel. In the transition between vowel and consonant according to the present invention, consideration has not to be taken into all cases but the transition of vowel and consonant marked on the keypad. In the case of vowel-tense consonant coupling or vowel-aspirated consonant coupling, “control” intervene and the ambiguity is eliminated as described in the prior document. There are 100 vowel-consonant transitions to be considered in order to minimize ambiguity in the present invention, because 10 basic vowels can be coupled to 10 basic consonants.

| | [symbol] | [symbol] | [symbol] | [symbol] | □ | [symbol] | [symbol] | [symbol] | [symbol] | [symbol] |
|---|---|---|---|---|---|---|---|---|---|---|
| ├ | 279,212 | 959,099 | 29,646 | 428,535 | 247,828 | 80,150 | 11,806 | 518,082 | 40,308 | 6,586 |
| [symbol] | 25,906 | 1,085 | 0 | 738 | 792 | 35 | 119 | 78,932 | 0 | 353 |
| ┤ | 242,768 | 458,525 | 8,371 | 160,597 | 124,782 | 108,462 | 246,867 | 321,690 | 4,345 | 41,811 |
| [symbol] | 113,869 | 389,804 | 13 | 90,500 | 20,691 | 20,687 | 2,560 | 289,185 | 0 | 188 |
| ⊥ | 219,181 | 169,654 | 9,420 | 98,620 | 33,304 | 15,091 | 57,446 | 327,617 | 819 | 35,134 |
| [symbol] | 6,630 | 96 | 0 | 35 | 12 | 133 | 52 | 58,727 | 0 | 0 |
| [symbol] | 185,775 | 356,806 | 6,294 | 247,889 | 53,552 | 4,991 | 15,514 | 115,604 | 353 | 22 |
| [symbol] | 18,264 | 12,874 | 0 | 9,720 | 1,178 | 3 | 152 | 5,999 | 0 | 0 |
| — | 67,121 | 1,257,457 | 6,293 | 1,124,896 | 165,315 | 76,138 | 35,019 | 135,432 | 2,798 | 11 |
| \| | 120,173 | 513,390 | 5,147 | 349,276 | 165,382 | 114,747 | 16,736 | 18,849 | 6,554 | 162 |

The frequency of consonant-vowel transition is disclosed in the documents as follows. Now, a description will be given as to the frequency of syllables comprising “consonant+vowel”. Syllables comprising “consonant+vowel+consonant” are considered in connection with the frequency of vowel-consonant transition and will not be further described, which is one of the important factors of the present invention. There are 100 cases of consonant-vowel transition with 10 basic consonants and 10 basic vowels marked on the keypad.

| | [symbol] | [symbol] | [symbol] | [symbol] | □ | [symbol] | [symbol] | [symbol] | [symbol] | [symbol] |
|---|---|---|---|---|---|---|---|---|---|---|
| ├ | 502,524 | 296,811 | 897,014 | 196,349 | 97,044 | 60,513 | 290,744 | 267,256 | 237,792 | 464,916 |
| [symbol] | 291 | 12,804 | 72 | 985 | 0 | 4 | 893 | 83,643 | 71 | 19 |
| ┤ | 89,961 | 19,528 | 45,578 | 102,124 | 27,712 | 30,089 | 359,602 | 316,253 | 47,416 | 14,969 |
| [symbol] | 16,418 | 15,948 | 227 | 75,046 | 61,288 | 2,516 | 2,916 | 129,252 | 21,664 | 10,619 |
| ⊥ | 516,086 | 36,934 | 300,318 | 380,780 | 84,377 | 158,435 | 109,473 | 83,875 | 85,105 | 33,326 |
| [symbol] | 63,053 | 923 | 5 | 13,606 | 3,960 | 0 | 1,727 | 103,925 | 6,227 | 8,326 |
| [symbol] | 118,349 | 19,314 | 57,531 | 23,938 | 101,694 | 156,664 | 195,481 | 113,884 | 141,096 | 30,472 |
| [symbol] | 13,117 | 2,750 | 245 | 12,903 | 711 | 873 | 1,820 | 65,492 | 154 | 3,285 |
| — | 337,994 | 29,868 | 34,051 | 47,815 | 6,370 | 4,361 | 75,980 | 224,471 | 4,443 | 4,954 |
| \| | 333,052 | 177,228 | 22,754 | 262,480 | 74,913 | 80,932 | 206,345 | 1,087,100 | 442,346 | 58,134 |

The frequencies of vowel-consonant and consonant-vowel transitions on the above table are not a relative value but an absolute value, and thus added together to present a table representing the coupling frequency of consonant and vowel. The following table presents the sum of frequencies of vowel-consonant and consonant-vowel transitions. More specifically, the syllables comprising “consonant+vowel” make up about 54% in Korean to form the frequency of vowel-consonant transition being 54%, and the syllables comprising “consonant+vowel+consonant” make up about 46% to form the frequency of consonant-vowel transition being 46%. But The table below shows that the frequency of vowel-consonant transition makes up 50% as that of consonant-vowel transition does, because the syllables of “consonant+vowel” and those of “consonant+vowel+consonant” share about halves in Korean.

| | [symbol] | [symbol] | [symbol] | [symbol] | □ | [symbol] | [symbol] | [symbol] | [symbol] | [symbol] |
|---|---|---|---|---|---|---|---|---|---|---|
| ├ | 781,736 | 1,255,910 | 926,660 | 624,884 | 344,872 | 140,663 | 302,550 | 785,338 | 278,100 | 471,502 |
| [symbol] | 26,197 | 13,889 | 72 | 1,723 | 792 | 39 | 1,012 | 162,575 | 71 | 372 |
| ┤ | 332,729 | 478,053 | 53,949 | 262,721 | 152,494 | 138,551 | 606,469 | 637,943 | 51,761 | 56,780 |
| [symbol] | 130,287 | 405,752 | 240 | 165,546 | 81,979 | 23,203 | 5,476 | 418,437 | 21,664 | 10,807 |
| ⊥ | 735,267 | 206,588 | 309,738 | 479,400 | 117,681 | 173,526 | 166,919 | 411,492 | 85,924 | 68,460 |
| [symbol] | 69,683 | 1,019 | 5 | 13,641 | 3,972 | 133 | 1,779 | 162,652 | 6,227 | 8,326 |
| [symbol] | 304,124 | 376,120 | 63,825 | 271,827 | 155,246 | 161,655 | 210,995 | 229,488 | 141,449 | 30,494 |
| [symbol] | 31,381 | 15,624 | 245 | 22,623 | 1,889 | 876 | 1,972 | 71,491 | 154 | 3,285 |
| — | 405,115 | 1,287,325 | 40,344 | 1,172,711 | 171,685 | 80,499 | 110,999 | 359,903 | 7,241 | 4,965 |
| \| | 453,225 | 690,618 | 27,901 | 611,756 | 240,295 | 195,679 | 223,081 | 1,105,949 | 448,900 | 58,296 |

Minimization of ambiguity in using RSM on a keypad is generally known as NP-hard problem. On the keypad marked with consonant and vowel pairs as disclosed in the prior document of the applicant, minimization of ambiguity in using in the (base/simple) RSM for entering a consonant with one strike and a vowel with two strokes can be modeled by the linear programming (LP), which is the critical advantage of the invention of the applicant. The above table is an integrated frequency table presenting the integrated frequency for optimizing the mathematical modeling in the present invention.

Forming a pair of consonant to minimize ambiguity is called “grouping problem”, since the term “grouping” used in the prior document means division of characters to be assigned to each button into groups as “grouping”, the term “assigning” means assignment of character groups to each button, and the term “arranging” means arrangement of assigned characters to each lattice element of the button.

If the subscript of each row is defined as i, the subscript of each column as j, the number of assigned consonants or vowels being n, the objective equation and the constraint expression are given by:

$$Min {\sum }_{i = 1}^{n} {\sum }_{j = 1}^{n} {c}_{ij} {x}_{ij}$$

$$st {\sum }_{i = 1}^{n} {x}_{ij} = 1 , i = 1 , 2 , , n$$

$${\sum }_{i = 1}^{n} {x}_{ij} = 1 , j = 1 , 2 , … , n$$

$${x}_{ij} = 0 , 1 ∀ i , j$$

where xᵢⱼ is 0 when the i-th vowel and the j-th consonant are not grouped, or 1 when the i-th vowel and the j-th consonant are grouped; and Cᵢⱼ is the integrated frequency of the case where the i-th vowel and the j-th consonant appear in succession.

The objective expression may be rewritten as:

$$Min Z = \begin{matrix}( 781736 * {X}_{1 \; 1} ) + ( 26197 * {X}_{1 \; 2} ) + & … & + ( 453225 * {X}_{1 \; 10} ) \\ + ( 1255910 * {X}_{2 \; 1} ) + & … & + ( 690618 * {X}_{2 \; 10} ) \\ ⋮ & & ⋮ \\ + ( 471502 * {X}_{10 \; 1} ) + & … & + ( 58296 * {X}_{10 \; 10} )\end{matrix}$$

The constraint expression may also be rewritten likewise. With the mathematical model as well as the coefficient (i.e., transition frequency or coupling frequency) defined, the above equation can be solved by way of the commercial LP (Linear Programming) package. The solutions to the equation are given as follows, provided that the coefficients are the values of the above integrated frequency table divided by 50 due to limitations of the program used by the applicant:

| | |
|---|---|
| X(1, 6) = 1 => ( [symbol] , [symbol] ) | X(6, 2) = 1 => ( [symbol] , [symbol] ) |
| X(2, 4) = 1 => ( [symbol] , [symbol] ) | X(7, 8) = 1 => ( [symbol] , [symbol] ) |
| X(3, 9) = 1 => ( [symbol] , [symbol] ) | X(8, 1) = 1 => ( [symbol] , [symbol] ) |
| X(4, 7) = 1 => ( [symbol] , [symbol] ) | X(9, 10) = 1 => ( [symbol] , [symbol] ) |
| X(5, 5) = 1 => ( [symbol] , [symbol] ) | X(10, 3) = 1 => ( [symbol] , [symbol] ) |
| TOTAL COST = 12,241 | |

However, the grouping that minimizes ambiguity is not considered as best, because the positional discrimination of characters on the keypad is also an important factor.

If solving the problem to minimize the transition (or coupling) frequency, it is possible to detect a pair of consonant and vowel that minimizes ambiguity. Otherwise, if solving the problem to maximize the transition frequency, ambiguity may increase but there are more cases of pressing the same button in entering characters, thus enhancing the convenience for entry. Unfortunately, the user has to deal effectively with ambiguity.

Maximization of the transition (or coupling) frequency is considered very efficient in case where a confirm button is selected by syllables (letters in Korean) with pairs of vowel arranged to enter a consonant with one stroke and a vowel with two strokes, or where a confirm button is selected to confirm one syllable. In this case, all consonants and vowels not marked on the keypad can be entered without ambiguity in such a manner that the succession controls are assigned to buttons not designated as a confirm control button, and selected according to the repeating frequency of the control button. However, this makes the user take the trouble to press the confirm button by syllables. As described in the prior document, one succession control button, if input order of control button is same for basic consonant and basic vowel (i.e., before entry or after entry), may be applied to both subsequent consonants and subsequent vowels. This is of course equally applied to the case where the confirm button by syllables is not input.

Maximization of the transition (or coupling) frequency is to solve the objective expression as “Max Z= . . . ” by attaching a minus symbol “−” to the coefficient (i.e., the number of frequency) or using a value obtained by subtraction of each coefficient from the largest coefficient as a coefficient in solving the minimization problem. This can also be solved by way of the commercial LP package.

It is the core of the embodiment of the present invention to describe those cases that cause much ambiguity (e.g, vowel-consonant transition, consonant-vowel transition, etc.) although all cases possible are not considered, and to provide an approach for optimization based on the frequency number of consonant-vowel coupling in those cases.

The core of the method for minimizing the ambiguity with a mathematical model may be summarized as follows. 10 consonants and 10 vowels are grouped in pairs, each pair of consonant and vowel being arranged to each button, so as to select a consonant with one stroke of each button and a vowel with two strokes of each button. Here, ambiguity occurs most frequently in the case where consonant and vowel concerned with vowel-consonant transition (vowel-consonant coupling in a syllable comprising “consonant+vowel+consonant”) and consonant-vowel transition (consonant-vowel coupling in a syllable comprising “consonant+vowel”) are assigned to the same button. In regard to this, the “integrated frequency table” presenting coefficients used in modeling of the assignment problem by the linear programming method based on the frequency number according to each transition. The use of a commercial program makes it easier to detect a group of consonants and vowels that will optimize the mathematically modeled problem.

This may be equally applied to other languages (e.g., Hindi and the Myanmar language) of which one syllable comprises “consonant+vowel” or “consonant+vowel+consonant”. For languages other than Korean, data about the transition (or coupling) frequency of consonant and vowel are presented in the existing documents, or otherwise collected with a properly designed corpus in the same manner as described in the case of Korean. That is, as described above, if syllables comprising “consonant+vowel” form 70% in Hindi and ones comprising “consonant+vowel+consonant” form 30%, the frequency of vowel-consonant transition makes up 70% and that of consonant-vowel transition makes up 30%. Syllables comprising “vowel+consonant” in Hindi may be erroneously recognized as “consonant+vowel” (irrespective of the form of the previous syllable). To avoid ambiguity, the frequency of such vowel-consonant transition (for simplicity, referred to as “0 vowel-consonant transition” or “0 vowel-consonant coupling”) is made 100% to obtain an integrated frequency table for three cases, and consonants and vowels are grouped in pairs of consonant and vowel so as to minimize the integrated frequency table.

According to the prior document, 10 basic vowels and 9 representative consonants are grouped into pairs of vowel and consonant. For this purpose, a pseudo consonant is added to perform the grouping in the same manner as grouping 10 consonants and 10 vowels. The transition (or coupling) frequency of the pseudo consonant and the 10 basic vowels is set to “zero”.

4. Method for Using Vowel Elements in Korean

4.1.1 Applying CPM for Aspirated Consonant and Tense Consonant

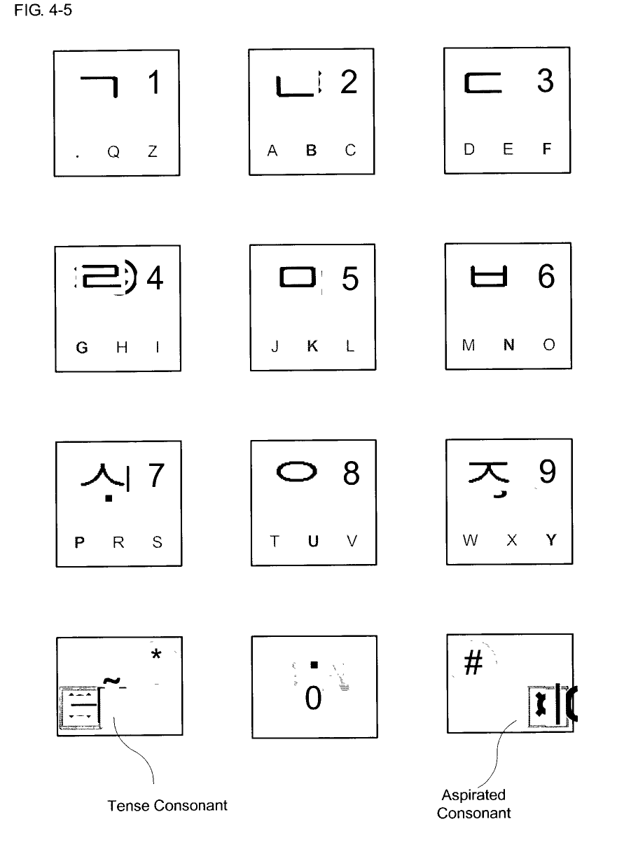

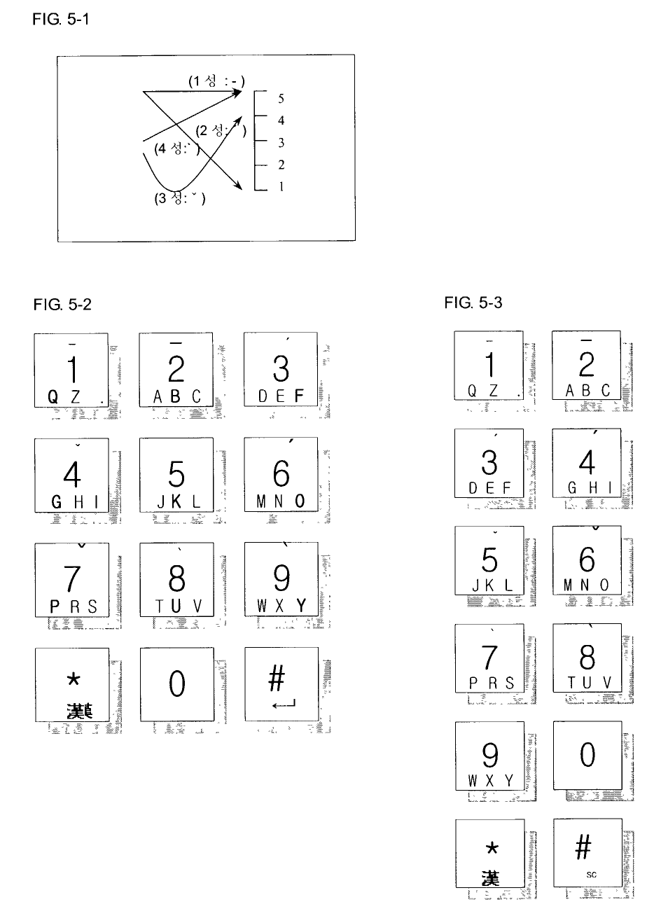

Use can be made of the vowel elements (e.g., —, [symbol] and .) of Korean. Reference will be given to FIG. 4-5. The present invention assigns 9 out of 10 basic consonants to each of numeral buttons [1] to [9], the vowel elements of Korean such as “—” and “ [symbol] ” to the buttons [*] and [#] at the bottom of the keypad, and the vowel element “.” to the button [0]. Although various assignment methods are possible, expediently, the present invention exemplifies the assignment and arrangement method shown in FIG. 4-5. Of course, the basic consonant and the vowel elements are arranged at the position of the base lattice element, and there is no need of using PWSM in selecting the arranged basic consonants and vowel elements.

In applying CPM for aspirated consonant and tense consonant, “aspirated consonant control” and “tense consonant control” are each assigned to a button designated for “—” or “ [symbol] ”, and arranged to one of the other lattice element closest to the base lattice element. That is, the aspirated consonant control and the tense consonant control are selected with two strokes of the control button. Alternatively, aspirated consonant (or tense consonant) control may be additionally arranged to the tense consonant (or aspirated consonant) control button and selected with three strokes of the control button. As described in the prior document, “ [symbol] ” has no aspirated consonant so that “ [symbol] ” is regarded as aspirated consonant and tense consonant. There is no need of marking the aspirated consonant or tense consonant control on the buttons and the user has only to memorize the entry rules for aspirated consonant or tense consonant control.

If the selection state of aspirated consonant control is represented by “{aspirated consonant}” and control before input character is applied to the example of FIG. 4-5, the entry is given as [symbol] ={aspirated consonant}+ [symbol] =[*]+[*]+[1]. Likewise, [symbol] ={tense consonant}+ [symbol] =[#]+[#]+[1]. If the tense consonant control is selected with three strokes of the aspirated consonant control button, the entry is given as [symbol] ={tense consonant}+ [symbol] =[*]+[*]+[*]+[1].

There is no ambiguity in the present invention which the aspirated consonant and tense consonant controls share the same button with vowel elements of “—” and “ [symbol] ” and RSM is applied. The reason for this lies in that the vowel “—” rarely appears twice in succession in a word as is the marked characteristic of Korean so that two strokes of the button [*] for selection of the aspirated consonant control is not recognized as selection of two vowels “—” and “—” in succession. The same applies to the case of the vowel “ [symbol] ”. In a word “ [symbol] ” (in the example, [8]+[0]+[0]+[#]+[#]+[0]+[*]+[#]), the vowel “ [symbol] ” appears twice subsequent to the vowel element “.”, and thus “[#]+[#]” is not recognized as selection of the tense consonant control but a vowel. Because the vowel element “.” cannot terminate the word of this example, the selection of [#] subsequent to the vowel element “.” is recognized as a vowel. There is no ambiguity even if the aspirated consonant and tense consonant controls are assigned to a button designated for “—”, since the vowel “—” rarely appears in succession.

Nine of ten basic consonants are assigned to nine buttons [1] to [9]. The other one is not assigned to the button and expediently called “the consonant out of 9 buttons (COO9)”. The consonant out of 9 buttons can be regarded as the affixed or succession character of one of the ten basic consonants in consideration of similarity in pronunciation or shape, and control processed. For example, if control before input character applies while “ [symbol] ” is not allocated to the button but regarded as the affixed character (aspirated consonant or tense consonant) of “ [symbol] ”, the entry is given as [symbol] =[*]+[*]+ [symbol] , or [symbol] =[*]+[*]+[*]+ [symbol] , or [symbol] =[#]+[#]+ [symbol] . Regarding “ [symbol] ” as the affixed character (aspirated consonant or tense consonant) of “ [symbol] ” in consideration of pronunciation and shape in FIG. 4-5, the entry is given as [symbol] =[*]+[*]+ [symbol] , or [symbol] =[*]+[*]+[*]+ [symbol] , or [symbol] =[#]+[#]+ [symbol] .

In this case, the character control processed (i.e., “ [symbol] ” in FIG. 4-5) is preferably one of the characters destitute of aspirated consonant nor tense consonant (e.g., [symbol] , [symbol] , [symbol] , [symbol] and [symbol] ) for more convenience in inputting characters. Of course, the basic character control processed (i.e., “ [symbol] ” in FIG. 4-5) is preferably one of the characters destitute of aspirated consonant nor tense consonant to make the entry of character more convenient. Here, “ [symbol] ” is given as an example of control processing because it is an character of the lowest use frequency among those destitute of aspirated consonant nor tense consonant. Another reason for the selection of “ [symbol] ” as an example of control processing is similarity of pronunciation and shape as the relation between another normal sound and aspirated consonant.

Here, 10 basic consonants (normal sounds) are preferably allocated to 10 numeral buttons in order to use Korean for memorization of telephone numbers and various codes. For this purpose, “ [symbol] ” is additionally assigned to a button designated for “.” (i.e., button [0] in FIG. 4-5) and arranged to the lattice is for selecting “ [symbol] ” with three strokes of the corresponding button. It is necessary to select “ [symbol] ” with three strokes of the corresponding button in order to eliminate ambiguity in RSM, because “.” appears twice in succession very frequently. In this case, although “ [symbol] ” is not arranged at the third lattice physically close to the base lattice, the user has only to know that “ [symbol] ” can be selected with three strokes of the corresponding button. This means that three strokes of button [0] selects “ [symbol] ” and that all basic consonants can be arranged to the respective numeral buttons for use purpose in memorization.

To make characters more distinguishable in FIG. 4-5, consonants are marked in blue, vowels or vowel elements in red, and numerals in black. “—” marked in blue on the button [0] indicates that “ [symbol] ” is assigned to the button [0] because “. +—+0 (zero)” is largely shaped like “ [symbol] ”.

That is, the consonant out of 9 buttons is regarded as the affixed character of a specific basic consonant and input by CPM, or entered with three strokes of a button designated for “.”.

4.1.2 Basic Consonant Combination Processing of Tense Consonant, and Hiding/Non-Hiding Repeated Selection Processing of Tense Consonant and Aspirated Consonant

It is possible to process a tense consonant by way of a combination of basic consonants in a method using the vowel elements of Korean. Because one basic consonant is assigned to each numeral button in the method using vowel elements, ambiguity may occur (first ambiguity, the ambiguity between full codes) such as “ [symbol] ”.

Such ambiguity can be avoided with an “index” as described in the following embodiment. If entering an aspirated consonant by way of a combination of basic consonants, CPM is used only for entry of the aspirated consonant to simplify the rules of entry. The aspirated consonant control can be assigned to a proper lattice element as described in the prior document. For example, the aspirated consonant control is removed in FIG. 4-1 or 4-2.

It is described above that basic consonant, aspirated consonant and tense consonant can be entered in sequence (for example, [symbol] , [symbol] and [symbol] ) according to the number of times of pressing the corresponding button (for example, [symbol] =[1], [symbol] =[1]+[1], and [symbol] =[1]+[1]+[1]). This case may also have a first ambiguity as described in the prior document. Specific examples of the case that causes ambiguity will not be described here. It may be possible to mark basic consonants alone, or all of basic consonants, aspirated consonants and tense consonants on the buttons. This allows the succession characters (for example, [symbol] and [symbol] ) to be selected by RSM.

Expediently, a method for marking only the representative character and selecting its succession characters by RSM is referred to as “Hiding Repeat Selection Processing Method (HRSPM)”. The adjunctive priority of aspirated consonant and tense consonant can be given in the order of basic consonant, tense consonant and aspirated consonant. For example, assignment to the lattice elements is defined as [symbol] (1st: position of the base lattice element), [symbol] (2nd), and [symbol] (3rd). That is, [symbol] =[1], [symbol] =[1]+[1], and [symbol] =[1]+[1]+[1]. This is processing (or hiding repeated selection processing) tense consonants by the combination of basic consonants and selecting aspirated consonants by the hiding repeating selection processing.

Although this method of the present invention differs in the adjunctive priority of the succession characters from the hiding repeat selection method described in the prior document, it makes it possible to enter a tense consonant with two strokes of a corresponding numeral button (combination of basic consonants), thereby making the entry more natural from a viewpoint of the user.

In this case, “ [symbol] ” is entered with three strokes of the button [0], which entirely enhances consistency in the method employed because the relation between “ [symbol] ” and “ [symbol] ” is similar to that between normal sound (basic consonant) and aspirated consonant in shape and pronunciation and an aspirated consonant can also be entered with three strokes of a corresponding numeral button.

It is of course possible to enter an aspirated consonant with three (or two) strokes of a button designate for the basic consonant, or by CPM, likewise as “ [symbol] ” is entered with three strokes of the button [0], or by CPM in which “ [symbol] ” is regarded as the affixed character of “ [symbol] ”. When the user enters an aspirated consonant by CPM, the system discriminates the aspirated consonant without ambiguity (ambiguity between full codes, i.e., first ambiguity). But, ambiguity may occur while entering an aspirated consonant with three strokes of the button arranged for the corresponding basic consonant. The same applies to the case of a tense consonant.

That is, the user may enter an aspirated consonant by CPM or the hiding repeat selection method on the same keypad. The same applies to the case of a tense consonant. For example, if the aspirated consonant control is selected with two strokes of the button [*] and aspirated consonant and tense consonant are selected with two and three strokes of a button for corresponding basic consonants, respectively, the entry of “ [symbol] ” is given as “ [symbol] =[1]+[*]+[*]+[#]+[0]+[1]+[1]+[1]+[#]”. That is, the first “ [symbol] ” is entered by CPM and the second “ [symbol] ” is by RSM. Likewise, the entry of “ [symbol] ” is given as “ [symbol] =[1]+[#]+[#]+[#]+[0]+[1]+[1]+[1]+[#]”.

The sequent order of selecting aspirated consonant and tense consonant may be defined as is convenient for the user in entering aspirated consonant and tense consonant by the non-hiding repeat selection method or the hiding repeat selection method.

4.1.3 Combination of a Method Using Pairs of Basic Consonant and Basic Vowel and a Method Using Vowel Elements

A system using vowel elements is a simplified form of the keypads shown in FIGS. 4-1, 4-2 and 4-3, and compatible with the character input methods disclosed in the prior document. That is, the character input method of the present invention is applicable to the keypad in which 10 basic vowels are additionally marked on the buttons, and further to the full keypad on which basic consonants, basic vowels, extended vowels, aspirated consonants and tense consonants are all marked.

In the example of FIG. 4-2, tense consonant control and aspirated consonant control are assigned to the button [*] or [#], which is not specifically marked on the keypad but known to the user. According to the present invention, “—” or “ [symbol] ” is marked on each button so that the user is allowed to select a method using vowel elements or a method using pairs of basic consonant and basic vowel. For example, in FIG. 4-5, eight basic vowels except for “—” and “ [symbol] ” existing as vowel elements are assigned to eight of the nine buttons [1] to [9] so as to select the eight basic vowels with two strokes of the buttons designated for the basic vowels. Similarly, CPM or the repeated selection processing method is applicable to the entry of aspirated consonant or tense consonant. For example, if eight vowels other than “—” and “ [symbol] ” are added to FIG. 4-5, as illustrated in FIG. 4-2, the entry of ‘ [symbol] ’ is given as “ [symbol] ”=[1]+[3]+[3]+[7]+[#]+[2]. If it is convenient, the user may enter the vowel “ [symbol] ” of “ [symbol] ” by RSM and the vowel “ [symbol] ” of “ [symbol] ” with a button designated for vowel elements. Here, there is no need of converting the input mode while different methods are applied in entering vowels within a word.

Alternatively, eight vowels are additionally assigned to buttons [1] to [9], and two basic consonants (e.g., [symbol] or [symbol] ), destitute of aspirated consonant nor tense consonant and similar to each other in shape and pronunciation, are arranged to the button not designated for the vowel, followed by applying RSM. The help of “index” in this case can overcome ambiguity that may occur.

5. Method for Overcoming Ambiguity Through Index

In RSM, several words are represented by same code to cause ambiguity. As previously described in the prior document, such ambiguity occurs between “ [symbol] ” and “ [symbol] ” in the example of FIG. 4-1. Generally, entry is done word by word. For example, the word “ [symbol] ” exists but the word “ [symbol] ” doesn't. Both the words have the same code in FIG. 4-1. In connection to this, a client terminal or a server prepares an index for those words that may cause ambiguity in relation to a specific keypad and a specific character input method. If the user enters “ [symbol] ” or “ [symbol] ”, which is not distinguishable from the other even in the presence of a time delay, the system may recognize “ [symbol] ” as a desired word (hereinafter, referred to as “target word”) because “ [symbol] ” is registered as a correct word in the index. This applies only to the case where ambiguity occurs between the words not distinguishable by the system. If possible, the system (on the side of the client or server) distinguishes the words by the help of a time delay value, which is previously set by the system or the user. That is, when the user enters “ [symbol] ” with pauses (by means of time delay, space, or selection of the left move button or another special button) intentionally, the system outputs “ [symbol] ” as the target word even though the output word is a grammatically incorrect word.

To prepare the index, the system may register only correct words (e.g., “ [symbol] ”) or incorrect words (e.g., “ [symbol] ”) as ambiguous words. Alternatively, the system may register both correct words and incorrect words, provided that it has information for deciding whether a certain word in the index is correct or incorrect.

This applies to all cases using RSM on the keypad. For example, the same applies to the case where ambiguity occurs between “ [symbol] ” and “ [symbol] ” in the input method by the Samsung Electronic Co., Ltd. in Korea. It also applied to the case where pairs of consonant and vowel are arranged to each button as shown in FIG. 4-1 to select a consonant with one stroke of the corresponding button, an aspirated consonant with two strokes, a tense consonant with three strokes and a vowel with one stroke, and a syllable confirm button is selected syllable (letter) by syllable (letter). Even when the system outputs “ [symbol] ” temporarily in response to the entry of “ [symbol] ” by the user, it may correct the misspelled word as “ [symbol] ” with reference to the index just as the moment the word is ended (for example, by entry of space).

When the index for a word exists in both the client terminal and the server, the system first looks up a correct word in the index of the client terminal and, if failed, finally in the index of the server.

As well understood, it is reasonable that the system can distinguish a word from another one by the help of a word-discriminating factor, which is given, for example, between spaces, the head of a word and a space, a space and the tail of a word, and a space and a mode transition. Decision on a correct word with reference to the index is achieved word by word. So, the system refers to the index to decide a correct word the moment that the user enters a word-discriminating factor.

This applies to all cases where ambiguity occurs in RSM. Ambiguity may occur, for example, between “ [symbol] ” and “ [symbol] ” where the final and initial consonants of a word belong to the same button in the input method by Samsung Electronics. Co., Ltd. in Korea. Here, the system does not recognize syllable (letter) by syllable (letter) in entering characters with codes assigned by characters, so that it naturally outputs “ [symbol] ” in response to the entry of “ [symbol] ” from the keypad. If it is possible in this case to determine which one of the two words should be the target word even in the presence of a time delay, the system (terminal or server) determines the target word with reference to the index. Discrimination of the target word with reference to the index irrespective of the time delay may be more efficient in this case, because the system will decide the target word as “ [symbol] ” in all cases even though the initial consonant “ [symbol] ” of “ [symbol] ” is selected subsequent to the final consonant “ [symbol] ” of “ [symbol] ”.

It is apparent that this is not limited to Korean and may be applied to all languages using RSM. For example, when the user enters [2]-[2]-[2] in entering characters of English or other languages in the English mode to cause ambiguity between “AB” and “BA”, the system may recognize “AB”, which is registered in the index as a correct word, and provide it as the target word. If ambiguous words entered are all registered as correct words in the index, the system first provides the word of the highest use frequency to the user and enables the user to finally determine the target word.

If the system recognizes all words corresponding to an ambiguous input word as correct with reference to the index, it allows the user to select the target word by the help of a proper (visual or auditory) method.

In order to allow the user to determine the target word, the system lists the plural words recognized as correct in the order of use frequency (or priority) on a display window and urges the user to select the target word by up-and-down scroll or numeral buttons corresponding to the displayed order of the words. Alternatively, the system displays only one word of the highest use frequency on the display window and, if the word is not the target word, causes the user to select a control (expediently, referred to as “next word control”) for displaying the next word of the secondly highest use frequency. If the next word is also not the target word, the system enables the user to continue searching for the target word in the same way. After searching the target word, the user is allowed to decide the target word by selecting another button (i.e., any button not designated for selection of the next word control, such as selection of another characters, space, or mode transition).

Here, both the PWSM and the RSM (base/simple) are applicable to selection of the next word control. If the next word control is arranged at the position of the base lattice element of a specific button, it can be selected with one stroke of that specific button.

6. Simple Code Application Method and SIM/CIM

6.1 Production of Character-Associated Simple Code

Entry of characters is indispensable in access to the information system with a data communication terminal. There are some cases where such characters are coded into numerals. A miniaturized data communication terminal usually has an interface in the form of a normal keypad. Here, the term “code” as used herein refers to any types of code, the examples of which are numerous including telephone number, stock index (listed company) code, city code, quarter code, subway station code, bank code, etc. Coding of various names has an advantage in the sense of simplification of entry.

The data communication terminal as used herein includes any type of data communication terminals such as PC, mobile communication equipment, smart phone, PDA, bi-directional text transceiver, ATM (Automated Teller Machine), or the like, as well as non-communication terminals such as electronic diary. The information system as used herein includes any type of systems accessible visually via GUI or only aurally accessible, such as ARS. The system also includes a server system, and in a broad sense, a client software of the terminal in communication with the server system.

Alphabet allocated to the keypad may be used for memorization of various codes. There are many approaches for this purpose, including simple naming, initial naming or full naming. Now, a description will be given as follows.

Simple naming is to designate a numeral associated with a given word or phrase as a code. For example, a Korean company name, “ [symbol] ” has a simple code “1799” associated with [symbol] , [symbol] , [symbol] and [symbol] , as shown in FIG. 4-2. In this case, characters [symbol] , [symbol] , [symbol] and [symbol] in “ [symbol] ” associated with the simple code “1799” are marked in bold, so that the user can notice the simple code of a specific word with ease. Furthermore, the simple code can be extracted from a word or phrase. The simple code of “ [symbol] ”, for example, is specifically not limited to “1799”, because the code consists of numerals associated with any character belonging to a given word in the simple naming. For example, as the simple code of “ [symbol] ” is set as a value associated with [symbol] , [symbol] , [symbol] and [symbol] , that of “ [symbol] ” may become “1729” associated with [symbol] , [symbol] , [symbol] and [symbol] , or “1949” associated with [symbol] , [symbol] , [symbol] and [symbol] , or “13294293” associated with all characters constituting “ [symbol] ”. Expediently, designation of a code associated with all characters forming a given word or phrase is referred to as “Fully Associated Simple Naming (FASN)”, and designation of a code associated with part of characters forming a given word or phrase is referred to as “Partially Associated Simple Naming (PASN)”. In either case, simple naming (i.e., simple code) is associated with characters constituting a given word or phrase. The same applies to other languages as well as Korean. For example, “captain” may have a simple code of “2786” associated with consonants “CPTN” as a partially associated simple code, which is expediently referred to as “Consonant-Associated Simple Code”.

A phrase as well as a word can be coded by simple naming. From a phrase “ [symbol] ” in the example of the prior document, letters (syllables) full of meaning are used to extract a simple code “8314” mapped to [symbol] , [symbol] , [symbol] and [symbol] . For English, “data tonight” in the example of the prior document may have a simple code “3886” associated with characters having a phonetic value, such as d, t, t and n.

Initial naming is a special case of the partially associated simple naming. For Korean, initial naming designates a numeral mapped to the initial consonant of a syllable (letter) as a code. Expediently, this method is referred to as “Syllable-Based Initial Naming (SBIN)”. For example, the syllable-based initial code of “ [symbol] ” extracted by the syllable-based initial naming is “1799” associated with the initial consonant of each syllable (letter). The syllable-based initial naming also applies to other languages as well as Korean. For example, an English word “entertainment” has an syllable-based initial code “3886” associated with e, t, t and m according to the syllable-based initial naming. The syllable-based initial naming is more useful for Korean in which one syllable constitutes one letter.

Likewise, the initial naming is also applicable to a phrase. For example, a phrase “ [symbol] ” in the example of the prior document may have an initial code “81” associated with the initial characters of each word, [symbol] and [symbol] . An English phrase “dance with the wolf” has an word-based initial code “3979” associated with d, w, t and w according to the word-based initial naming. The word-based initial naming is more useful for every language when the code is assigned to the entire phrase.

Expediently, both a simple code (i.e., fully associated simple code and partially associated simple code) and an initial code (i.e., syllable-based initial code and word-based initial code) are called “simple code (in a broad sense)” or “short-cut code”. Especially, each of fully associated simple code, consonant-associated simple code, syllable-based initial code and word-based initial code follow regulations in their production and thus are generally used in practice. In addition, simple codes generated by others according to the regulations may also be readily used.

Full naming is an input value of a given word or phrase to be coded according to a specific character input method and thus variable depending on the used character input method. A numeral value corresponding to a given word or phrase is coded character by character. For example, “ [symbol] “in the prior document has a full code “7745888944” according to PWSM (disclosed in the prior document) as illustrated in FIG. 4-2. The full code of “ [symbol] ” according to BRSM (disclosed in the prior document) becomes “7448884”. If using another keypad different from that of FIG. 4-2 or another character input method, a specific full code value may be given according to the keypad or the character input method.

6.2 Production of Tone-Based Simple Code

For entry of ideographic characters, such as Chinese characters, numerous characters have to be reasonably assigned to the buttons on the keypad. One method is to map the English phonetic spelling corresponding to characters on the English keypad. Another method is mapping the tones of the Chinese characters to the buttons on the keypad.

All Chinese characters have five tones, the first tone (tone symbol “—”), the second tone (tone symbol “'”, the third tone (tone symbol “ [symbol] ”), the fourth tone (tone symbol “ [symbol] ”) and non-tone. Each of the five tones can be assigned to two buttons on the keypad. Various arrangements are available in this basic pattern. For example, the first tone can be assigned to buttons [1] and [2], the second tone buttons [3] and [6], the third tone buttons [4] and [7], the fourth tone buttons [8] and [9], the non-tone buttons [5] and [0]. This allocates the first to fourth tones to the upper, lower, right and left buttons on the keypad for the purpose of convenience in use. It may be more effective visually if pairs of buttons are different in color from one another. The pairs of buttons are arranged as [1,2][3,6][4,7][8,9] to form a [symbol] shape. Alternatively, the first to fifth tones are each assigned to two of ten buttons [1] to [0] in sequence.

It becomes the problem to determine which one of buttons [1] and [2] should be designated for the characters having the first tone. There are many solutions to this problem. For example, one method involves classification of the Chinese characters based on the stroke count (i.e., as a means for determining the complexity of a Chinese character). If the stroke count of a character having the first tone in a word or phrase is equal to or less than a predetermined value (for example, 5), the character is regarded as assigned to the button [1] (i.e., the button of the smaller numeral out of buttons [1] and [2]). Otherwise, the character is regarded as assigned to the button [2] (i.e., the button of the larger numeral out of buttons [1] and [2]). Although the reference stroke count is 5 in the above example, it is not fixed as the averaged stroke count of Chinese characters common in use but may be set as a reference value such that half of the Chinese characters have a stroke count less than the reference value and the other half of the Chinese characters have a stroke count exceeding the reference value.

Instead of the stroke count, the number of constituent characters may be used to determine the complexity of a Chinese character. The term “constituent character” as used herein refers to a character distinguishable in a Chinese character. For example, [symbol] comprises two constituent characters [symbol] and [symbol] , and [symbol] comprises three constituent characters [symbol] , [symbol] and [symbol] . If the number of constituent characters in a given Chinese character is equal to or less than a predetermined value (for example, 2), the Chinese character is regarded as assigned to a button of the smaller numeral out of the two buttons corresponding to the same tone. Otherwise, if the number of constituent characters exceeds the predetermined value, the Chinese character is regarded as assigned to a button of the larger numeral.

The tones of the Chinese characters are presented in FIG. 5-1. The tone symbol is commonly used as shown in FIG. 5-1 in the present invention. FIG. 5-2 is an exemplary view of a keypad according to the present invention, in which the tone symbol is marked on the button of the keypad. Because the first tone is assigned to buttons [1] and [2], the first tone symbol “—” is marked on the buttons [1] and [2]. The first tone symbol marked on the button [1] is smaller than that on the button [2], which makes the user to know intuitively that a Chinese character of which the complexity (e.g., the stroke count or the number of constituent characters) is equal to or less than a predetermined level (e.g., 5 strokes or 2 constituent characters) is regarded as assigned to the button [1]. Several Chinese words can be coded on the keypad with reference to FIG. 5-2 as follows. In the following example, the reference value for determining the complexity of a given Chinese character is “5 strokes”. The symbol above the character is the tone symbol.

[symbol] =>3686 (Λ which has the second tone corresponds to either of the buttons [3] and [6], and may be regarded as associated with the button [3] because its stroke count is 2 that is less than the reference stroke count of 5. The same applies to the rest.)

[symbol] =>3689 (Example: 700- [symbol] =>700-3689)

[symbol] =>3616

[symbol] =>4716

[symbol] =>7612

In the case where different words generate the same code in the system, a serial number is added to the end of a word character string. For example, when a character having the same numeral code as the code “7612” of [symbol] exists in a system, a serial number is added as [symbol] 1 to produce a code of “76121”.

Alternatively, when the user enters a character in order to designate a tone-based simple code, the system may extract a simple code corresponding to the input character according to predefined regulations for producing tone-based simple codes and display the extracted simple code to the user. The Chinese character, which is an ideogram, has a difference from a phonogram in that the system has to know the tone and the stroke count (or, the number of constituent characters) as well as the mapping information between characters and numerals.

The present invention proposes a method for mapping Chinese characters to the buttons on a keypad based on the tone and the complexity of the characters. Because five tones are assigned to two buttons as is characteristic of the Chinese character, it may be intuitively considered more convenient for the user to make the current arrangement of the keypad in 2 columns and 5 rows. For example, buttons [1] and [2] are allocated to the first row of the keypad, buttons [3] and [4] on the second row, buttons [5] and [6] on the third row, buttons [7] and [8] on the fourth row, buttons [9] and [10] on the fifth row, buttons [*] and [#] on the sixth row. The first to fourth tones and the non-tone are each assigned to the two buttons on each row of the keyboard, and the system determines whether a given Chinese character corresponds to the button on the first column or on the second one, based on the complexity of the character. Such an arrangement of the 2*6 keypad is illustrated in FIG. 5-3. In this case, with each tone assigned to the two buttons on every row of the keypad, the system determines whether a given character corresponds to the button on the first column or the second one, based on the complexity of the character.

If using multiple methods instead of one standard, the buttons of the keypad assigned to the tones are varied and hence the code value generated also changes. Accordingly, there is a need of conversion between a code generated by a specific method (e.g., the code by the 3*4 keypad in the present invention) and a code generated by another method (e.g., the code by the 2*6 keypad in the present invention). Such conversion may take place at the server or in the client software of the terminal. In either case, conversion occurs in the entire system (server or client terminal), and re-conversion to a desired code can be achieved with the knowledge about the method applied to the entire system. For example, when a desired code value necessary in the system is obtained by the method 2 while entering the code value of [symbol] according to the method 1, it is possible to determine a code value according to the method 2.

To generate a code from [symbol] rather than [symbol] , [symbol] is entered in combination with a specific functional key to mark [symbol] in bold and generate the code “76” for [symbol] Furthermore, when the user intends to generate a code from part of a character (for example, [symbol] of [symbol] ) (in order to avoid the overlap of the same code and etc), the system marks [symbol] of the character in bold and thereby generates a code. In this case, the simple code of [symbol] (with [symbol] marked in bold) is not “7612” but “7312”.

It is a general method for entering a Chinese character that the pronunciation of the Chinese character is written in English and changed to a convertible Chinese character upon selection of a “Chinese character conversion button” to make the user choose a corresponding Chinese character.

In Chinese, the full code is determined based on the English pronunciation of Chinese. Furthermore, when there are multiple words of the same pronunciation, the full code is determined in combination of the code based on the English pronunciation, the Chinese character conversion button, and the priority of the target word in the words of the same pronunciation. In the example of the present invention, the Chinese character conversion button on the keypad is the button [*] in FIGS. 5-2 and 5-3. If a specific description is not given as to the English input method, it should be understood that the present invention uses the known input method.

It is necessary in the present invention to provide a “specific functional button” for simple naming of Chinese. That is, the user enters English, selects the Chinese character conversion button to choose a desired Chinese character and then enters a specific functional key for simple naming (hereinafter, referred to as “simple code (SC) button”) to display the corresponding character and its constituent characters in sequence, among which the user selects a constituent character for producing a simple code. In the example of the present invention, the simple code key is the button [#].

According to the above example, when the user enters [symbol] of [symbol] and select the simple code button, the system displays [symbol] and its constituent characters [symbol] and [symbol] in sequence. If the user chooses [symbol] the system displays [symbol] of [symbol] in bold and thereby recognizes the corresponding simple code as 3. The simple code “3” for [symbol] in which only [symbol] stands out in bold is stored in the system for future use, or is interpreted from the character.

In regard to Chinese, it is necessary to provide a Chinese dictionary in the entire system (of client or server) for the purpose of naming of codes. That is, when the user enters a named character (i.e., word or prase that is corresponding to smiple code), the system looks up the named character in the dictionary with reference to the tone and the stroke count (or the number of constituent characters) of the character, thereby mapping the named character to a numeral code. It is assumed that the dictionary contains the tones and the stroke counts (or the number of constituent characters) of Chinese characters, which are used in mapping the Chinese characters to numerals on the keypad. The user or the system operator must be enable to add words not listed in the dictionary and store mapping information such as the tone of Chinese characters. Without a Chinese dictionary in the entire system, it is necessary to enable the user to enter not only a word as named characters but also mapping information such as the tones of the characters, or numeral codes corresponding to the characters.

For Chinese characters, production of a tone-based simple code is advantageous in that the simple code is not generated based on the English pronunciation and each character is intuitively mapped to one numeral code. Typically, the company name and the city name in Chinese comprise a fixed number of characters and the length of the tone-based simple code is equal to the number of characters (i.e., the number of tones). Thus, advantageously, the simple code is constant in length and usable even in the keypad that has no English alphabet marked thereon.

The same applies to every language that has tones, such as Thai or the Myanmar language. All syllables of Thai have tones, which are divided into five classes, i.e., even tone and first to fourth tones. It is therefore possible to map each tone to two buttons on the keypad as in the case of Chinese. In mapping one tone to two buttons on the keypad as in Chinese, the system has to determine which one of the two buttons should be designated for the tone, based on the stroke count or the number of constituent characters. There are many possible factors for such determination. For example, in Thai that has two types of vowels coupled by syllables, i.e., a simple vowel and a long vowel, the simple vowel is mapped to a button of the smaller numeral and the long vowel is mapped to a button of the larger numeral.

And there are two types of tones; one is called “tangible tone” marked with a tone symbol, and the other is called “intangible tone” marked without a tone symbol. Five intangible tones are expressed according to the type of consonant, the relative length of the vowel, and the presence of the final consonant. The consonant of Thai comprises nine medium consonants, ten higher consonants and twenty-three lower consonants. Even tangible tones of the same tone symbol become different from one another according to the type of the consonant. Therefore, four vowels marked with one of the four tone symbols and one vowel marked without a tone symbol are each mapped to two buttons on the keypad, and a simple code is determined according to whether the vowel to be coupled is a simple vowel or a long vowel. Such a simple code is specifically referred to as “tone-symbol-based simple code”.

The Myanmar language has three tones, i.e., first, second and third tones. All these three tones are marked with a tone symbol. Thus each of the three tones can be mapped to three of the buttons [1] to [9]. For example, a syllable of the first tone is mapped to the three buttons on the first row, i.e., buttons [1], [2] and [3]. Syllables of the same tone are classified into three parts: one is a syllable destitute of the final consonant (e.g., consonant+vowel), another is a syllable destitute of the initial consonant but having the final consonant (e.g., vowel+consonant) and the other is a syllable having both the initial consonant and the final consonant (e.g., consonant+vowel+consonant). For example, a syllable of the first tone is mapped to any one of the buttons [1], [2] and [3], and if the syllable comprises “consonant+vowel” without the final consonant, it is associated with the button [1]. All syllables of the Myanmar language have a tone symbol and the rules for construction of syllables are routinely understandable. It is therefore advantageous in that the symbol-based simple codes for every word can be produced automatically according to the rules.

6.3 Unique Simple Code

If the client terminal is charge of decoding the simple code (i.e., when the client terminal has a specific word or phrase and its simple code value), the word or phrase corresponding to the input simple code is transferred to the server. In the case where the server requests the simple code according to the feature of the application while the client terminal is enable to decode the simple code, the client terminal sends the simple code itself (i.e, displays the numeral) to the server, which then decodes the simple code. Thus the simple code is decoded in either the client terminal or the server.

With a simple code for multiple words or phrases, there can be many words or phrases corresponding to the same simple code. Such ambiguity between the simple codes in CIM is expediently called “second ambiguity”. Although the system may add a serial number to the simple code to store a unique code value in this case, the second ambiguity occurs because the user normally uses the simple code associated with a specific word or phrase. Of course, the system has to recommend such words or phrases based on the priority for use to the user. With the same simple code for different words or phrases, the system adds a serial number to the simple code according to the priority based on the use frequency of the words or phrases and utilizes the serial number as priority in recommendation of words or phrases to the user. Here, the system does not necessarily add a serial number to the simple code and may have separate information about the priority.

For example, when the simple codes of “ [symbol] and “ [symbol] ” are both “9196” as a syllable-based initial code, the system adds a serial number to the simple code according to the use frequency of each word and uses the serial number as priority for recommendation of words to the user. If “ [symbol] ” has the higher use frequency, the system gives the priority to that word and defines a new simple code “91961 ” for “ [symbol] ” and “91962” for “ [symbol] ”. Expediently, such a simple code with a serial number is called “unique simple code” and a overlapped simple code having no serial number is called “simple code”, both of which are just referred to as “simple code”.

6.4. Use of Simple Code

The following is the example of simple codes (for example, syllable-based initial codes) assigned to various city names, which are useful in the railway information system, or the like:

[symbol] =78, [symbol] =78, [symbol] =39, [symbol] =739, . . . .

Because “ [symbol] ” and “ [symbol] ” have the same syllable-based initial code, the system adds a serial number to the simple code as “ [symbol] =781 ” and “ [symbol] =782”. If the user sends only “78” to the system, then the system properly performs feedback (e.g., provides a list of [symbol] and [symbol] or informs of the list in a voice) so that the user can select either [symbol] or [symbol] . Upon the user entering “781 ” initially, the system recognizes the simple code as “ [symbol] ”.

If the server requests the word “ [symbol] ” instead of the simple code “78”, the client terminal interprets the simple code “78” as “ [symbol] ” and sends it to the server. In the case where the server requests the simple code according to the feature of the application while the client terminal is enable to decode the simple code, the client terminal has only to send the simple code itself to the server.

The simple codes of stock index (listed company) codes are given as follows, which are useful in various stock information system, or the like:

[symbol] =3098, [symbol] =39397, [symbol] =83643, . . . .

For example, [symbol] , [symbol] , [symbol] , [symbol] [symbol] ” used as a base for the syllable-based initial code of “ [symbol] ” are marked in bold to provide a more powerful visual effect to the user.

The simple codes of bank codes are given as follows, which are useful in the ATM and various financial information systems:

[symbol] (bank)=14, [symbol] (bank)=82, . . . .

It is apparent that a predefined simple code can be used for entry of a word or phrase in such a manner that the user enters the predefined simple code and then the client (terminal) provides the user with the decoded simple code. Such a method is called “Short-cut Input Method (SIM)”, which will be described later together with “Concurrent Input Method (CIM)”.

6.5. Automatic Alteration of Priority Based on Selection Frequency

Initially, “ [symbol] ” takes first priority over “ [symbol] ”. If a specific user tends to choose “ [symbol] ” very frequently, it is possible to give priority to “ [symbol] ” over “ [symbol] ”. For this purpose, use can be made of, if not specifically limited to, a method that involves exchanging serial numbers to alter the priority. Alternatively, the system may change separate information about the priority.

The system or the user may (re)designate criteria used in deciding whether the use frequency of “ [symbol] ” is remarkably high. For example, when the user chooses “ [symbol] ” in at least eight cases out of ten, the existing priority is automatically altered. The system may request the user to confirm the alteration of the priority according to given options.

6.6 Automatic Designation of Simple Code and Marking Simple-Code-Associated Characters in Bold

Consonant-associated simple code, syllable-based initial code and word-based initial code other than fully associated simple code follow regulations in their production. Hence, the user enters a specific word or phrase to designate a simple code for the word or phrase while the production regulations of simple codes are defined, and then the corresponding simple code is automatically extracted and stored in the system. Here, characters associated with the simple code are marked in bold to increase convenience for use. In regard to English, the characters associated with the simple code may be embossed as capital letters.

The prior document discloses the “SIM” and the “short-cut/full CIM”. The simple code for short-cut input may be defined in the system and then altered by the user. The user may further designate a simple code for another word or phrase.

Designation of a simple code for a new word or phrase may follow defined regulations for production of simple codes, such as fully associated simple code, partially associated simple code, consonant-associated simple code, syllable-based initial code, or word-based initial code, as disclosed in the prior document. To produce a simple code for “dance with the wolf” from a word-based initial code, for example, the user has to enter “dance with the wolf” and then “3983” as a word-based initial code in the simple code create mode. Likewise, in order to produce a simple code for “ [symbol] ” from a syllable-based initial code, the user has to enter “ [symbol] ” and then “9196” in the simple code create mode.

It is however possible to designate a simple code for a specific word or phrase automatically without taking the trouble to enter a desired code type, if the user make the system memorize the desired type of the simple code. For example, when the user sets a desired type of the simple code as the syllable-based initial code in the system and simply enters “ [symbol] ”, the system designates the simple code for “ [symbol] ” as “9196” in an automatic manner.

It has been described that characters of English associated with the simple code can be capitalized and marked in bold. In regard to this, when the user designates the use of capitals in the simple code in advance and enters “DaTe ToNight”, the system automatically determines the simple code as “3886” corresponding to the capitals “DTTN”. Otherwise, if the user enters “ToNight ShoW”, the system automatically determines the simple code as “8679” corresponding to the capitals TNSW”.

6.7 SIM and CIM Using Simple Code for Word or Phrase

As the user enters a simple code (unless specified otherwise, the simple code includes the initial code, which is the special case of the simple code), the system (client system or server system) can recognize the simple code as its corresponding word or phrase. It is thus apparent that when the system recognizes a specific simple code as a corresponding word or phrase and displays the word or phrase, the user can utilize the displayed word or phrase in entering a new word.

In the character input method used in other countries, a character input system is realized in such a manner that the terminal (client system) stores the index having “fully associated simple codes” assigned word by word and displays corresponding words of a given code input from the user according to the priority order by words, thus allowing the user to determine the target word. For more information, reference to the Internet sites, http://www.tegic.com and http://www.zicorp.com is recommended. Hereinafter, such a method will be referred to as “fully associated SIM” or “foreign method”.

A comparison between the methods by Tegic Co. and Zi Corp. and the method for entering characters from a keypad according to the prior document of the applicant reveals that the character input method of the applicant assigns unique codes to each character and thereby allows the entry of a target character or a target word (phrase) with a full code, while the above-mentioned foreign method assigns fully associated simple codes to each word and allows the entry of a target word with the simple code.

The foreign method has the following drawbacks: (1) it allows exclusively the entry of predefined words, because the code is assigned to each word; (2) when different words share the same code, it is difficult to enter words less frequency used, because the user takes the trouble to select and confirm the target word with a toggle button or a move button; (3) words other than the target one may appear temporarily during inputting of the word; and (4) a large storage capacity and much cost are required to implement the system.

It is possible to assign a simple code (i.e., partially associated simple code or fully associated simple code) to a commonly used word or phrase and use the simple code in entering the target word or phrase. Of course, the commonly used word or phrase and the simple code of the commonly used word or phrase can be predefined in the system and provided to the user, or arbitrarily designated by the user. Alternatively, the user should be allowed to arbitrarily alter the simple code predefined in the system. It is advantageous to allow the user to designate the simple code, because the user is ready to get the knowledge of the simple code value for a specific commonly used word or phrase.

Expediently, in the present invention, a method for entering a target word or phrase using a simple code (including partially associated simple code, fully associated simple code and initial code) is called “short-cut input method (SIM)”, while a method for entering a target character using a full code is called “full input method (FIM)”. As will be described later, a combination of SIM and FIM can also be used. Expediently, such a method is referred to as “short-cut/full Concurrent Input Method (short-cut CIM)” or just “Concurrent Input Method (CIM)” for short.

Ambiguity occurs due to repeated selection in FIM, even though unique codes are assigned to each character and used to enter a target character. Expediently, such ambiguity is called “first ambiguity” or “character ambiguity”. On the contrary, ambiguity occurs between different words sharing the same simple code in a method such as the foreign method (i.e., SIM) in which codes are assigned to every word and used to enter a target word. Expediently, such ambiguity is called “second ambiguity” or “word (phrase) ambiguity”. The term “ambiguity” as used herein refers to the first ambiguity.

There are two scenarios: one is that the system first interprets a specific input value as a simple code (i.e., the first step of using SIM, or applying the short-cut input mode as the basic input mode), and without any simple code corresponding to the input value, the systemthen recognizes it as a full code (i.e., the second step of using FIM); and the other is that the system first checks whether a specific input value forms a full code (i.e., the first step of using FIM, or applying the full input mode as the basic input mode), and if the input value does not form a full code, the system then recognizes the input value as a simple code (i.e., the second step of using SIM). First interpretation of an input value as a simple code is applying the “short-cut input mode” as the basic input mode, while first interpretation of an input value as a full code is applying the “full input mode” as the basic input mode. Preferably, those who mostly input a commonly used word or phrase first apply SIM (i.e., applying the short-cut input mode as the basic input mode), and those who mostly do not input a commonly used word or phrase first apply FIM (i.e., applying the full input mode as the basic input mode).

In the full input mode designated as the basic input mode, the system first interprets an input value as a full code and erroneously recognizes an input simple code as an undesired word. For example, when BRSM is applied as FIM in FIG. 4-2, the simple code of a word “ [symbol] ” is designated as “877” (using a syllable-based initial code) and the system first interprets the input simple code “877” as a full code, thereby recognizing “ [symbol] ” as “ [symbol] ”. This applies to the words such as “ [symbol] ”, “ [symbol] ”, “ [symbol] ”, “ [symbol] ”, “ [symbol] ”, “ [symbol] ” or “ [symbol] ” in which the initial consonants of the second and third syllable (letter) correspond to the same button. On the other hand, in the short-cut input mode designated as the basic input mode, the system first interprets an input value as a simple code and erroneously recognizes an input full code as an undesired word. Such ambiguity between simple code and full code in CIM will be referred to as “third ambiguity”.

The third ambiguity can be overcome by using a toggle button or using a move button for the selection of the target word just like the conventional ones. Another alternative method is that the input mode is switched between full input mode and short-cut input mode in the unit of word before input values causing the third ambiguity are entered. This is similar to the method described in the prior document of the applicant in which “ [symbol] control” (i.e., Hiragana/Katakana transition control) is provided to enable entry of a Katakana word in the Hiragana mode or entry of a Hiragana word in the Katakana mode. For example, in the full input mode designated as a basic input mode, the system initially recognizes an input value after selection of the “short-cut/full” control as a simple code and provides to the user a target word corresponding to the input value with reference to the index. Likewise, in the short-cut input mode designated as a basic input mode, the system initially recognizes an input value after selection of the “short-cut/full” control as a full code. The “short-cut/full” control can be set to be selected before or after entry of the target word, but for the case of this control, it may be more convenient for the control to be set to be seleted before target word.

In CIM, the system may determine whether the input value is a full code or a simple code. Such a determination can be made in the unit of word as the index is referred in order to eliminate the first ambiguity as described above, or such a determination can be made in the course of entering the input value as described later.

While applying CIM in the full input mode designated as a basic input mode, the system checks input by input (i.e., value by value) whether every input code value forms a full code, determines the input value as a simple code at the time when the input code value is not considered to form a full code, and sends the user a word or phrase corresponding to the simple code with reference to the index, thereby enhancing the efficiency of CIM. Likewise, when applying CIM in the short-cut input mode designated as a basic input mode, the system checks whether every input code value is identical to the input value listed in the index, and recognizes the input code value as a predetermined full code of FIM at the time when there is no word matching the input value. This means that the third ambiguity can be eliminated at the beginning of the entry by using the regulations of FIM. The same applies to the case of using a character input method not disclosed as FIM in the prior document. Now, a description will be given as to FIM (base repeat selection method and part-whole selection method) disclosed in the prior document by way of the following examples.

For Korean, for example, the second and third input values of all syllables by the full code should be constant in using BRSM, which is illustrated in FIG. 4-2. If such a regulation is infringed, the input values are regarded as simple codes. When tense consonants can be processed through a combination of basic consonants, the associated criterion applies to all cases where BRSM is used.

In all languages, when PWSM is used as FIM, two input values correspond to one character and one input value is limited with respect to the other. In the case of English, for example, it is assumed that only a Horizontal Straight Combination (HSC) is used for English as shown in FIG. 1-1, not applying PWSM to input numerals. If the buttons [1], [2] and [3] on the first row are used as the first input value (first button) corresponding to one character, the second input value may correspond to the button [1], [2] or [3] on the first row. Likewise, when selecting the button [4], [5] or [6] on the second row after [2]+[1], the next value to form a full code is one of the buttons [4], [5] and [6] on the second row. When the input value violates this rule, the system regards the input value as a simple code and recommends a word corresponding to the simple code to the user. When using PWSM in FIG. 4-2, the next button in response to the input of the first button [1] for a full code is no more than button [1] or [2]. If this rule is infringed, the system regards the input value as a simple code rather than a full code and recommends a target word corresponding to the input value to the user with reference to the index. If four characters P, Q, R and S are assigned to button [7] as shown in FIG. 1-3, one of the four characters can be allocated to the lattice element that forms Vertical Adjacent Combination (VAC) in PWSM. When the button [7] is selected in order to form a full code for one character in this case, the next input button may be button [7], [8] or [9] on the third row, or button [4]. If this rule is infringed, the input value can be regarded as a simple code. The same applies to all languages if using PWSM as disclosed in the prior document.

FIG. 4-5 shows that one basic consonant is assigned to each button. Thus when syllable-based initial codes generally used in Korean are utilized as simple codes, the third ambiguity is avoidable in using both SIM and FIM. That is, when the user inputs syllable-based initial codes in using CIM, the input values from the second input (when inputting aspirated consonants and tense consonants by CPM) hardly form a full code. Thus the system refers to the index of simple codes and recommends proper words in the order of priority to the user. The similar principle can be applied to the input of a full code in CIM.

As described above, it is the core of the present invention that it is possible to determine during the input of characters whether the input value is a simple code or a full code in using CIM. The same principle applies to the case where the system uses the FIM of the prior document and the present invention, or other FIM. Particularly, the FIM of the applicant is advantageous, as described in the above example, in that whether the input values form a full code in FIM can be checked during the input.

Furthermore, the interpretation of a simple code or full code may be achieved in the client terminal or the server, as described in the prior document of the applicant. In looking up the target word in the index in order to overcome the first ambiguity (character ambiguity) in the prior document, a scenario that the system refers to the index of the client in the first stage and then the index of the server in the second stage applies to the interpretation of simple codes or full codes. Alternatively, the system may refer to the index of the server in the first stage and then the index of the client in the second stage. Furthermore, when the system interprets the input value as a simple code with reference to the index of the client in the first stage and then the index of server in the second stage but fails to find a simple code for the input value, it recognizes the input value as a full code in such a manner that it refers to the index of the client at the first stage or otherwise the index of the server at the second stage. Alternatively, the system interprets an input value as a simple code in the first stage with reference to the indexes of both the client and the server and then allows the user to select the target word. Any similar variations are possible in regard to the interpretation method (simple code or full code) and the interpretation site (client or server). That is, there are various combinations of the interpretation method (simple code or full code) and the interpretation site (client or server).

A concurrent use of SIM and FIM has advantages as follows: (1) in using FIM, the user is allowed to input almost all words including those nonexistent in the dictionary as well as predefined words; (2) the user can designate simple codes for the use of SIM on commonly used words or phrases as he/she desires (either partially associated simple codes or fully associated simple codes); (3) the user can designate partially associated simple codes to dramatically reduce the stroke count of the input; and word-based initial codes are assigned for phrases as well as words. On the contrary, the methods of foreign countries refer to the index for all input words word by word and thus have to use fully associated simple codes in order to minimize the probability that the same code is assigned to different words.

In addition, the system has an “index” containing specific words or phrases commonly used and code values for the words or phrases, which index requires a much lesser capacity of memory than that in the methods of foreign countries. Such an index may be the same as an “index” in the system that contains ambiguous words that are correct or incorrect in order to eliminate ambiguity.

Consonants have the sound values of a specific word in every language and a method for extracting consonants into an abbreviation has been widely used. For an example of English, the military term “captain” is abbreviated as “CPT” that comprises consonants having the sound values of “captain”, “sergeant” “SGT”, “staff sergeant” “SSG”, “sergeant first class” “SFC”. Although “captain” and “private” have two syllables, the consonants extracted as the abbreviation are considered as those that represent the respectively syllables. Accordingly, the simple code of “captain” is “278” associated with “CPT”.

The present invention in which the system is allowed to designate partially associated simple codes for commonly used words or phrases based on the syllable and apply SIM is very significant in a sense as well as the fact less labor is required in inputting characters. A syllable is phonetically defined as “psychological noumenon”. It is the consonant that has a sound value in the syllable. It is impossible to analogize “captain” out of the vowel extract “AAI”. But, “captain” can be easily analogized from the consonant extract “CPTN” or “CPT”. It is reported that any English sentence can be analogized from the constituent consonants without a vowel in each word. That is, the use of partially associated simple codes in association with each consonant constituting a syllable makes the user to apply SIM naturally and provides more convenience in use.

In particular, the simple codes can be used on the basis of abbreviations, because abbreviations are widely used in the English-speaking world and, for example, the listed company name is usually designated as an abbreviation.

The user is allowed to designate the type of simple code (i.e., partially associated simple code or fully associated simple code) for a specific word or phrase, which is advantageous in that it is easy to memorize the code values of commonly used words or phrases. Furthermore, if the user needs to use only a part of commonly used words or phrases, simple codes (e.g, 1, 2, 3, etc.) rather than the codes associated with the characters of the word or phrase are assigned to each word or phrase.

6.8 Grouping of Simple Code/Corresponding Word or Phrase, and Designation of Searching Range

There are many cases where much overlap occurs in designating simple codes for a plurality of words or phrases. The ambiguity between simple codes (i.e., the second ambiguity) can be reduced by grouping the word or phrases corresponding to the simple codes and searching simple codes only for a specific group of words or phrases. A word or phrase does not necessarily belong to only one group and may be included in a plurality of groups.

For example, the word or phrases after simple naming are divided into categories of listed company name, city name, commonly used word (or phrase), etc., and the group of commonly used words (or phrases) are subdivided into categories of society, politics, etc. Although this embodiment provides a two-staged tree type grouping, the grouping may be of a tree type with three, four or more stages. If the user (or system) limits the searching range of the simple code to the group of listed company names, the system searches named words or phrases corresponding to a specific input simple code within the category of the listed company name, thus reducing the second ambiguity. Likewise, when the user limits the searching range to the group of commonly used words or phrases, the system searches named words or phrases within the category of commonly used words or phrases and all its subgroups. If the user limits the searching range to the category of society in the group of commonly used words or phrases, the system searches named words or phrases within the category of society and its all subgroups.

6.9 Use of Switching Server

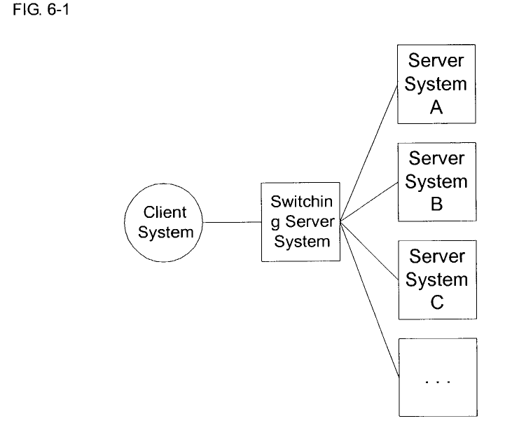

Interpretation of simple codes may be performed at the client terminal or the server. Alternatively, there may be used a switching server which is wholly charged with interpreting simple codes (including full codes under in some cases) to provide words or phrases corresponding to the simple codes to the client terminal or another server. Reference is made to FIG. 6-1. In the figure, the client terminal first decodes a simple code, and if it cannot interpret a word or phrase corresponding to the input simple code, the switching server interprets the word or phrase corresponding to the input simple code in the second stage. Upon failure, each server can interpret the word or phrase corresponding to the input simple code in the third stage. The third simple code-decoding server (expediently, called “third server”) is a server equipped with an application using the input simple code or its corresponding words or phrases.

With the switching server, the user inputs simple codes even when the third server requests a word or phrase other than the simple codes. Even though the third server does not store simple codes and words or phrases corresponding to the simple codes, the switching server interprets the simple codes input by the user to send the corresponding words or phrases to the third server.

When a simple code is input, the system looks up the words or phrases corresponding to the simple code in the index and feeds back the words or phrases to the client terminal or each server, input by input (i.e., value by value) or in the unit of words(i.e., word by word).

6.10 Division of Word Unit

The term “word unit” as used herein refers to the length of a word ranging from head to tail of the word. The word unit can be determined by a combination of all factors that discriminate between words, such as the head of a word, space, mode transition, enter, etc. For example, the entry of a word is identified through the head of a word˜the tail of a word, space˜space, space˜mode transition, and the like. The feedback in units of words can be performed through the programming languages that currently support the network environment.

6.11 Download of Simple Code and Corresponding Word or Phrase

It is also possible for the client to download the simple codes and the words or phrases corresponding to the simple codes from the server without directly storing the simple codes and their corresponding words or phrases.

Download may be achieved in the unit of words or phrases, or in the unit of the above-mentioned word or phrase groups (i.e, groups of the tree structure). If selecting a group, the client can download the subgroups as well as the selected group. During download, the client terminal may maintain the tree structure of the word or phrase group as set by the server, or assign the words or phrases belonging to the corresponding group and its subgroups to one group designated by the user. A switching server whose main function is decoding simple code can be in charge of this operation.

7. Input of Symbols

As described in the prior document, characters are arranged in the order of mother language, numerals and English alphabet, which are allocated “in the Order of Proximity to a BLE (OPBLE)”, and mother language and numerals are selected in the order of proximity to a BLE in BRSM. Likewise, numerals and English alphabet as well as mother languages assigned to a specific button can be entered using SCPM.

Furthermore, the present invention provides a method for efficiently entering various symbols not marked on the keypad (i.e., using the hiding control processing method), while such symbols are to be marked on the keypad in the prior document.

That is, the present invention assigns “symbol control” to the proper one of the lattice elements, which are allocated to controls in the invention of the prior document, and inputs a symbol by compounding the symbol control and a button (i.e., another button other than the control button) which is associated with specific symbol. Here, the button which is associated with dot “.”, for example, is button [5], because “ [symbol] ” is associated with the first syllable “ [symbol] ” of “ [symbol] (which is the Korean name of dot)”.

For example, as described in the prior document, the symbol control may be arranged at the position of a lattice element that can be selected with two consecutive strokes of button [*] in the example of Korean (FIG. 4-2). That is, the relation between a representative character and its succession characters is given as [symbol] (the representative character), [symbol] (2nd), symbol (3rd), . . . . For example, the entry of “.” is given as [symbol] ={symbol}+ [symbol] =[*]+[*]+[5] when the control is set to be selected before representative character, or [symbol] = [symbol] +{symbol}=[5]+[*]+[*] when the control is set to be selected after representative character. If the symbol control is arranged at the position of a lattice element that can be selected with three successive strokes of button [*], one selection of button [*] is added to the above example.

With only one symbol control, it is possible to input no more than 10 symbols even though symbols are assigned to each of 10 numeral buttons. For example, assignment of symbols to each button may be given as follows:

Button [1]: symbol “?” (“ [symbol] ” is associated with “?” in shape);

Button [2]: symbol “!” (“ [symbol] ” is associated with the first syllable “ [symbol] ” of “ [symbol] ” (which means “exclamation mark” in Korean)”;

Button [3]: symbol “$” (“ [symbol] ” is associated with the first syllable “ [symbol] ” of “ [symbol] (which means “dollar” in Korean”);

Button [4]: . . .

Button [5]: symbol “.” (“ [symbol] ” is associated with the first syllable “ [symbol] ” of “ [symbol] (which means “dot” in Korean”);

Button [6]: symbol “*” (“ [symbol] ” is associated with the first syllable “ [symbol] ” of “ [symbol] (which means “asterisk” in Korean);

Button [7]: symbol “,” (“ [symbol] ” is associated with the first syllable “ [symbol] ” of “ [symbol] (which means “comma” in Korean);

Button [8]: symbol ““”” (“ [symbol] ” is associated with the first syllable “ [symbol] ” of “ [symbol] (which means “quotation” in Korean);

Button [9]: symbol “˜” (vowel “13 ” is associated with “˜” in shape); and

Button [0]: symbol “@” (numeral “0” is associated with “@” in shape).

As described above, it is possible to input various symbols by compounding a symbol control and buttons that remind of the symbols. The symbols are assigned to each button in consideration of the relation between the name in the mother language or the shape of the symbol and the character on the button, or between the name in English or the shape of the symbol and the English alphabet on the button, or between the name or shape of the symbol and that of the numeral on the button. Such considerations are not specifically limited to those mentioned above and can be operationally reset by the user according to the user's liking.

Thus those symbols that are used frequently can be treated as if they are succession characters belonging to the numeral buttons readily reminding of the respective symbols. In the above example, the question mark “?” (the Korean name is “ [symbol] ”) is associated with button [1] designated for “ [symbol] ” in consideration of similarity of shape, because the dot “.” (the Korean name is “ [symbol] ”) more prevailing than the question mark has “ [symbol] ” as the initial consonant of the first syllable “ [symbol] ” of “ [symbol] ”.

Likewise, assignment of symbols to each button may be associated with English name/shape or Numeral name/shape. The following example applies in combination with mother languages.

Button [1]: symbol “?” (character “q” is associated with the first character of “Question mark”);

Button [2]: symbol “,” (“c” is associated with the first character of “Comma”);

Button [3]: symbol “.” (“d” is associated with the first character of “Dot”);

Button [4]: symbol “!” (“i” is associated with “!” in shape);

Button [5]: . . .

Button [6]: . . .

Button [7]: symbol “/” (“s” is associated with the first character of “Slash”);

Button [8]: symbol “:” (numeral “8” is associated with “:” in shape);

Button [9]: symbol “!” (“x” is associated with the pronunciation of “eXclamation mark”); and

Button [0]: symbol “@” (numeral “0” is associated with “@” in shape).

Assignment of symbols mainly using English is advantageous in that such assignment is applicable to the non-English-speaking world in which mother languages in combination with English ones are marked on the keypad. Using the similarity of shape between colon “:” and numeral “8” is generally acceptale irrespective of the language. Likewise, if not applied to the above example, the similarity of shape between comma “,” and numeral “9” may also be considered in assigning of “,” to button [9].

Symbol control may be allocated to a proper button. For English, unless another control is allocated to button [*] in FIG. 1-1, the symbol control may be selected with one stroke of button [*] (i.e., the symbol control is arranged at the position of the base lattice element of button [*]). For mother languages in Europe that include affixed characters with an affix, the symbol control may be arranged at the position of the base lattice element of button [0] or [#]. With the symbol control assigned to button [0], it may be desirable not to assign symbol “@” to button [0].

If control is set to be selected after representative character and the symbol control allocated to button [*], the entry of colon “:” in FIG. 1-1 is given as “:=[8]+{simbol}=[8]+[*]”.

As is apparent from the above example, it is possible to input no more than about ten symbols in the case where each button has the meaning of an associated symbol and the symbol control is allocated to one lattice element of the control button. The button marked with “s” can be designated for any one of symbols such as slash, semi-colon, period, etc., as it is associated with “slash” in the above example. As the button marked with “d” is associated with “dot”, the button of “i” is designated for “exclamation mark” in consideration of similarity of shape.

It is therefore possible to input more symbols by CPM with a plurality of symbol controls (e.g., symbol control 1, symbol control 2, . . . ). For example, the meaning of dot is assigned to the button associated with “d” (or the meaning of “ [symbol] ” is assigned to the button marked associated with “ [symbol] ”) to deal with comma “,” similar in shape as if it is the succession character of “dot”.

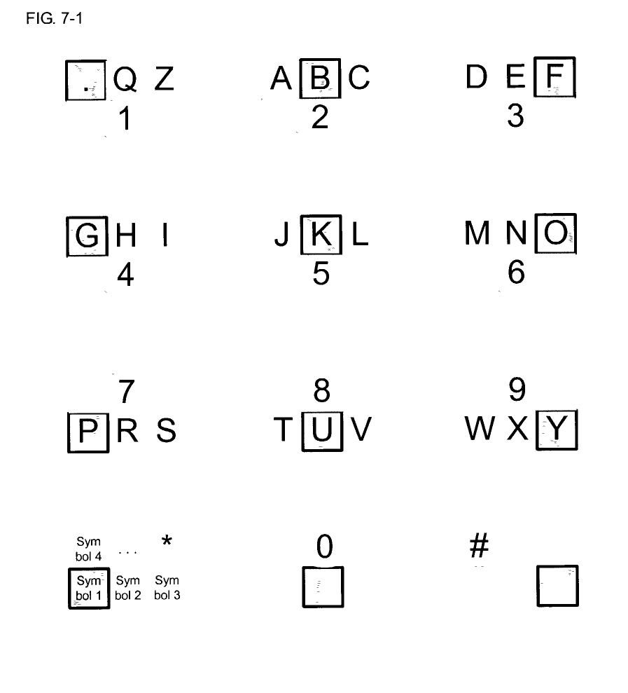

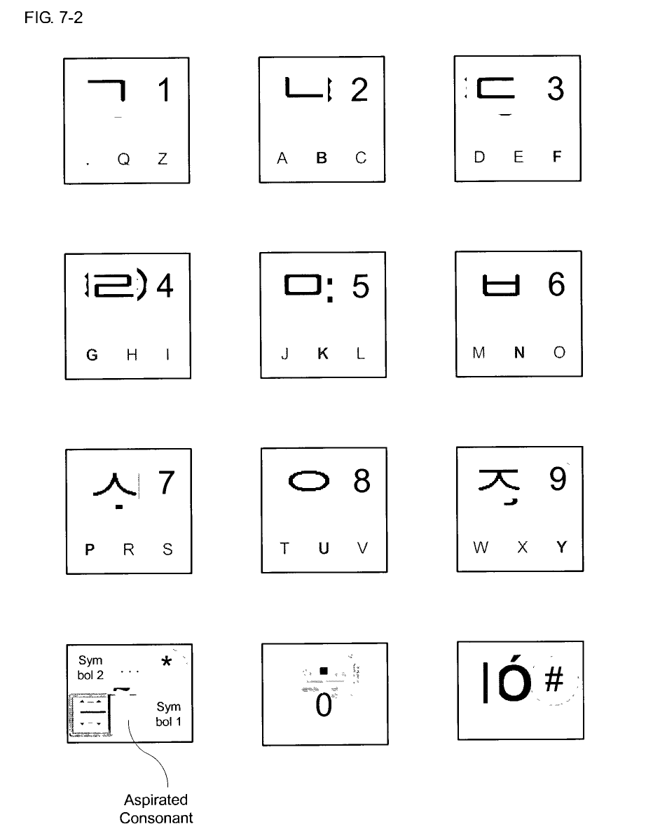

As shown in FIG. 7-2, in which the symbol control is added to FIG. 4-5, when control button is set to [*] and a control is set to be selected after the input of a representative character, entries are given as “dot (.)=[3]+{symbol1}=[3]+[*]+[*]+[*]”, and “comma (,)=[3]+{symbol2}=[3]+[*]+[*]+[*]+[*]”. From a standpoint of the chain type Succession Control Processing Method (SCPM), the entry is given as comma (,)=dot+{next}=dot+[*]=[3]+[*]+[*]+[*]+[*]. When an aspirated consonant is not input by CPM (i.e., assuming that there is no aspirated consonant control on the control button), “symbol control 1” is selected with two strokes of button [*] (i.e., Jump Control Processing Method is applied). Likewise, colon and semi-colon, which are similar in shape to each other, can be regarded as the succession characters assigned to the same button and input by CPM. The same applies to the other symbols.

Even with two symbol controls, i.e., “symbol control 1” and “symbol control 2”, the system has to assign the meaning of symbols to each button and memorize it, and thus has a limitation in the number of symbols for entry. Hence, the symbols are grouped as, for example, dot and comma, or colon and semi-colon and a plurality of symbol controls are arranged so as to input a large number of symbols.

It is preferable that the user optionally set the symbol grouping. The present invention presents a general example of symbol grouping. First, modifications of dot “.” can be grouped like as, for example, dot “.”, comma “,”, colon “:”, semi-colon “;”, quotation mark ““”, question mark “?”, exclamation mark “!” and so forth. This group comprises dot-shaped symbols, i.e., “zero-dimensional” symbols. Here, question mark “?” and exclamation mark “!” are both zero- and one-dimensional and thus included in the zero-dimensional (dot-shaped) symbol group. The adjunctive priority of the group is determined in consideration of the use frequency as described in the prior document. Preferably, the user may designate such considerations in determination of the priority. It is recommendable that the control is set to be selected after representative character, when a large number of symbols are regarded as the succession characters. A terminal with a display window may display the change of succession symbols when the control button is repeatedly pressed.

The user is allowed to optionally associate the dot-shaped (zero-dimensional) symbols with specific buttons. For example, dot “.” as a most frequently used and representative symbol of the group is regarded as a succession character belonging to button [3] which includes “d” of “dot”. If control after input representative character applies with the symbol control button designated as button [*] in FIG. 7-1, in which the symbol control is added to FIG. 1-1, entries are given as dot (.)=[3]+[*], comma (,)=[3]+[*]+[*], colon (:) =[3]+[*]+[*]+[*], semi-colon (;)=[3]+[*]+[*]+[*]+[*], and so forth. The dot-shaped symbols may be regarded as the succession characters belonging to the button [0] and associated with the button [0] because they are zero-dimensional form. Alternatively, they can be regarded as the succession characters belonging to the button [1], considering that dot “.” is the most fundamental form.

Next, line-shaped (i.e., one-dimensional) symbols are grouped like as, for example, slash “/”, hat mark “\hat{ }”, question mark “?”, exclamation mark “!”, round bracket 1 “(“”, round bracket 2 “)”, crooked bracket 1 “<”, crooked bracket 2 “>”, square bracket 1 “[”, square bracket 2 “]”, wave mark “˜” minus “−”, arrow 1 “←”, arrow 2 “→”, and so forth. The adjunctive priority of the group is determined in consideration of the use frequency or the like as described in the prior document, and associated with the succession characters of a specific button, which button may be properly designated. For example, the line-shaped symbols are regarded as the succession characters belonging to button [1], or button [5] that is designated for the character “|”.

Line-associated (i.e., two-dimensional) symbols are grouped like as, for example, at “@”, ampersand “&”, asterisk “*”, sharp “#”, dollar “$”, won “W+=”, yen “ [symbol] ”, . . . , heart 1 “ [symbol] ”, heart 2 “♥”, clover 1 “ [symbol] ”, empty triangle 1 “ [symbol] ”, empty triangle 2 “ [symbol] ”, empty triangle 3 “∇”, . . . , occupied triangle 1 “ [symbol] ”, . . . , [symbol] , [symbol] , [symbol] , [symbol] , and so forth. The adjunctive priority of this group is also determined in consideration of the use frequency or the like as described in the prior document, and associated with the succession characters of a specific button by using an adequate method. It is necessary that the symbols of this group should be associated with other buttons than those associated with the zero- and one-dimensional symbols.

Grouping the symbols into three groups, i.e., zero-, one- and two-dimensional symbol groups is advantageous in that the user has only to memorize three associated numeral buttons, but requires several strokes of the control button in entering rarely used symbols. To overcome this problem, the three groups are subdivided into subgroups as follows.

First, the two-dimensional symbols are subdivided into a line-associated symbol group (i.e., *, #, %, . . . ) and a second symbol group in the form of a simple closed curve (i.e., [symbol] , [symbol] , . . . ). In addition, a separate symbol group comprising pictures (i.e., [symbol] , [symbol] , [symbol] , [symbol] , [symbol] , . . . ) may be provided, which symbols are also regarded as the succession characters belonging to proper buttons. The symbols of the separate symbol group may be excluded from the previous symbol groups or not. The same applies to the other cases.

Another separate symbol group comprises one- or two-dimensional symbols that are used in the mathematical relation, for example, +, −, *, /, square root “√”, sigma “Σ”, integral “∫”, or the like. These symbols are also regarded as the succession characters belonging to proper buttons. Further another separate symbol group comprises directional symbols, for example, →, ←, ↑, ↓, [symbol] , [symbol] , [symbol] , [symbol] , [symbol] , [symbol] , [symbol] , or the like, which symbols are also regarded as the succession characters belonging to proper buttons.

Still further another separate symbol group is reasonably provided, comprising parentheses, for example, (, ), [,], {,}, <, >, or the like. The parentheses may also be subdivided into two subgroups, right parenthesis group and left parenthesis group.

With the three symbol groups and their subgroups provided, the characters belonging to the subgroups are optionally included in the three symbol groups, or not. It should be noted that those characters of the subgroups included in the three symbol groups acquire the lower priority.

The above-described symbol grouping applies to FIG. 1-1, in which the symbols of each group are regarded as the succession characters of specific button as follows. For example, zero-dimensional symbols are regarded as the succession characters of button [0], one-dimensional symbols as those of button [1], two-dimensional symbols as those of button [2]. In the two-dimensional symbol group, symbols in the form of a simple closed curve are regarded as the succession characters of button [8], symbols in the form of a picture as those of button [7], mathematical symbols as those of button [6], directional symbols as those of button [3], parenthesis symbols as those of any one of the rest numeral buttons. The method of associating symbol groups to each button is not limited to the above example and may be optionally set by the user.

After considering all the factors, it is the core of the present embodiment that symbols are divided into three groups (i.e., zero- one- and two-dimensional symbol groups) or subdivided into ten or less subgroups, and regarded as the succession characters belonging to specific buttons, as a result of which the present invention provides a method for entering almost all symbols. Furthermore, the individual symbol groups are regarded as the succession characters belonging to specific buttons, which are associated with the symbol groups in name, dimension, shape, or the like, so that the “Hiding Succession Control Processing Method (HSCPM)” can be used on the keypad having a simple arrangement of characters without any symbol marked.

The control button for symbol is button [*] or any one of up/down/left move buttons in this application, and the succession control button for numerals and English alphabet may be button [#]. For example, when button [#] is used as a succession control button, additional succession control for numerals and English alphabet is to be arranged to an available lattice element on button [#]. It is also possible in this case to skip the control not associated with the representative character and select the next available control, as described above.

8. Use of Move Button

8.1 Use of Move Button as Control Button

According to the prior document, the control button can be a button on a 4*3 keypad or a separate one, and the 4*3 keypad is short of control buttons in entering the language where a number of characters and its affixed characters exist. The present invention suggests that left/up/down move buttons not frequently used in the character input mode can be used as such control buttons as mentioned in the prior document. That is, the left/up/down move button is used in the character input mode as a control button, which is a separate button arranged out of the 4*3 keypad.

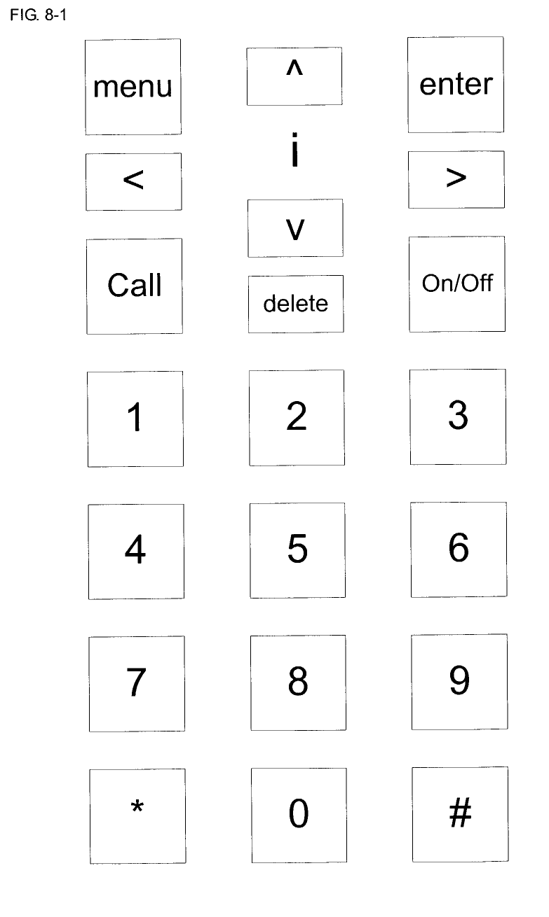

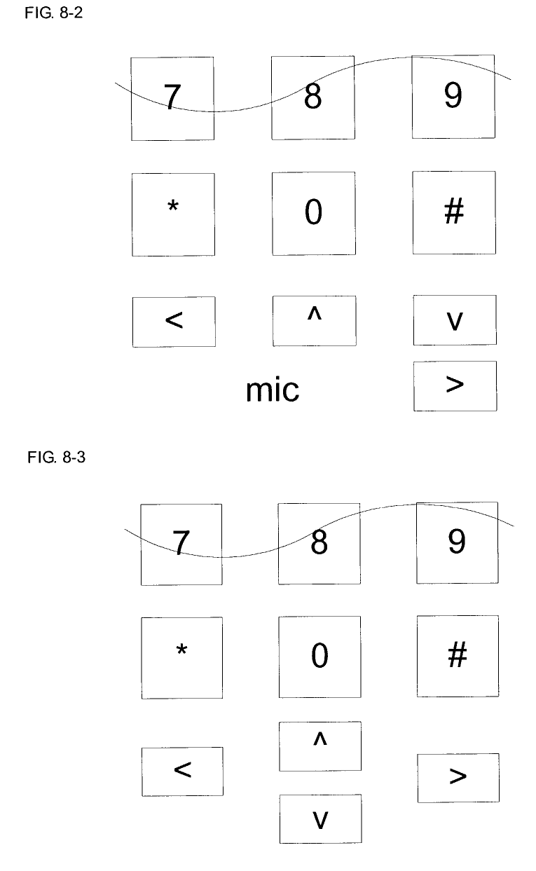

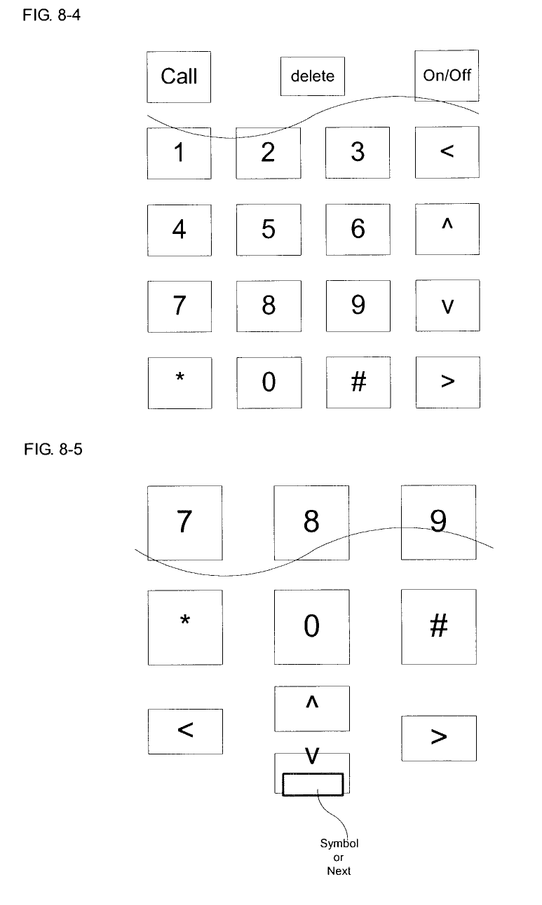

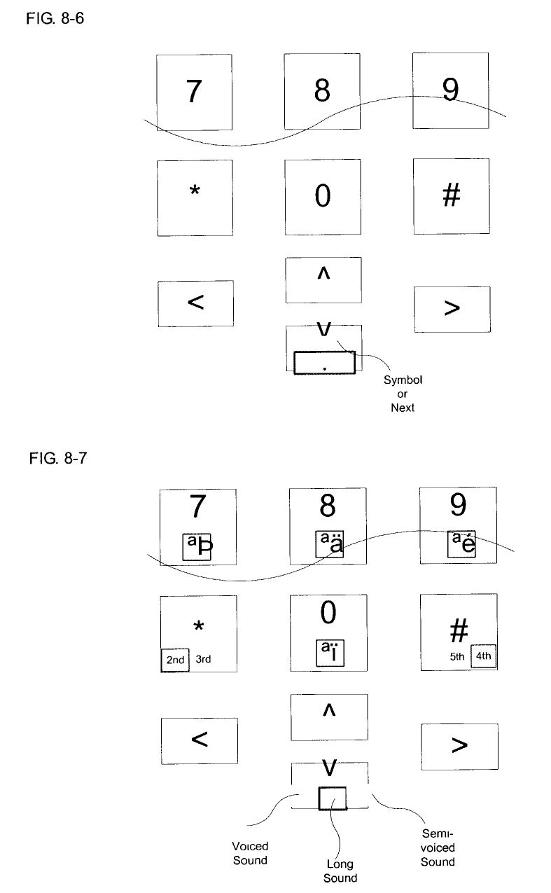

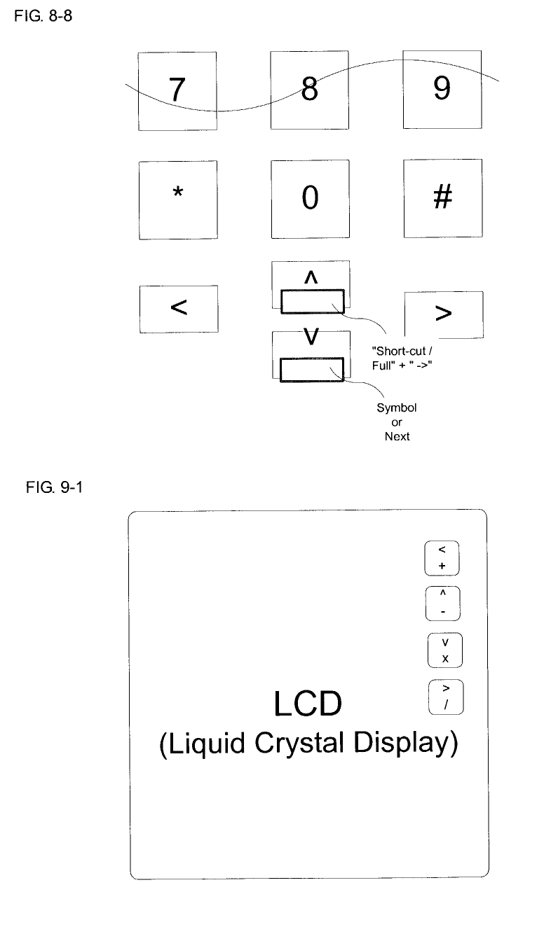

FIG. 8-1 illustrates the arrangement of buttons on a typical folder type mobile terminal. The button [|] indicated by a broken line is an Internet connection button, which may be provided or not according to the type of the terminal. The left move button is a space input button, especially used as a syllable (letter) confirm button for eliminating the first ambiguity in Korean. Up/down/left move buttons are useful as a move button for selection of menus in the menu select mode other than the character input mode. However, the up/down/left move buttons, particularly up/down move buttons, are not so frequently used in the character input mode.

8.2 Arrangement of Move Button Below Keypad

The up/down/left/right buttons are generally positioned above numeral buttons. In order to use these move buttons as a the button for character input in the character input mode, however, it is desirable the move buttons are to be arranged below the 4*3 keypad together with buttons [*] and [#] mainly used as control buttons. This is illustrated in FIGS. 8-2 and 8-3. Expediently, the embodiment of the present invention provides, if not specifically limited to, an arrangement of the move buttons below the 4*3 keypad.

As it is apparent from the figures, the 4*3 keypad and the up/down/left move buttons form a 5*3 keypad. This suggests that the individual buttons can be used as 15 (=3×5) lattice elements in PWSM. Likewise, the up/down/left move buttons have not to be necessarily arranged to form a 5*3 keypad as illustrated in FIG. 8-3.

8.3 Arrangement of Move Button on Left or Right Side

The up/down/left/right move buttons may be allocated to the left or right side to the 4*3 keypad. In this case, the move buttons and the 4*3 keypad form a 4*4 keypad in PWSM. FIG. 8-4 illustrates an arrangement of the up/down/left/right move buttons on the right side to the 4*3 keypad.

Advantageously, such an arrangement enlarges the size of the display on the terminal, following the trend of the terminal having a large-sized liquid crystal display (LCD), and acquires excellent features in combination with the method disclosed in Korean Patent Application Nos. 10-2000-0002081, 10-2000-0005671, 10-2000-0067852 and 10-2001-0002137 filed by the present applicant, in which the side battery is attached to the mobile terminal.

8.4 Use of Move Button as Control Button and Character Input Button

Hereinafter, the use of the move buttons will be described by way of the following examples, which are not limited to the scope of the embodiment of present invention.

8.4.1 Use of Move Button as Symbol Control Button

For Korean, aspirated consonant control and tense consonant control are allocated to buttons [*] and [#], respectively; or aspirated consonant control and tense consonant control are allocated to button [*], with basic vowel control and extended vowel control being allocated to button [#]; or only the extended vowel control is allocated to button [#]. In these cases, if control(s) after input representative character applies with the symbol control(s) allocated to button [*] or [#], entries are given in the sequent order of aspirated consonant, tense consonant and symbol(s) when the control button is repeatedly pressed. The same applies to other languages.

If the symbol control(s) is/are separately allocated to any one of the up/down/left move buttons, the symbol is entered with a combination of the button associated with the corresponding symbol group and the symbol control button designated for the symbol control. FIG. 8-5 shows the use of the down move button as a control button for selection of symbol control. If control after input representative character applies to the zero-dimensional symbol group, entries are given as: dot=[3]+[v], comma=[3]+[v]+[v], colon=[3]+[v]+[v]+[v], semi-colon=[3]+[v]+[v]+[v]+[v], and so forth.

8.4.2 Use of Move Button as Vowel Element Button for Korean

The prior document has a disadvantage that when using vowel elements “—”, “ [symbol] ” and “.” for Korean, vowel element “.” is arranged together with “ [symbol] ” to make it convenient for the user to input “ [symbol] ”. To overcome this problem, the present invention allocates the vowel elements on any one of the up/down/left move buttons. If the symbol control is allocated to the down move button, with the vowel element “.” on the up move button, two move buttons are to be used. Alternatively, the up/down/left move buttons are designated for three Korean vowel elements, respectively.

Similar to the case where the symbol control is allocated to the aspirated consonant control button, the Korean vowel element “.” can be arranged at the position of the base lattice element of any one of the up/down/left move buttons, with the symbol controls being assigned in the order of proximity to a BLE. This is illustrated in FIG. 8-6. As the vowel element “.” is not used alone, there is no ambiguity in selecting vowel elements and symbol controls by using RSM. In FIG. 8-6, one stroke of button [v] selects vowel element “.”, two strokes selects symbol control 1, and three strokes selects symbol control 2.

8.4.3 Use of Move Button as Affix Control Button for Japanese

For Japanese, the characters in the 50-sound diagram are mapped to each button and the 2^{nd} and 3^{rd} succession controls are allocated to button [*], the 4^{th} and 5^{th} succession controls allocated to button [#] according to the assignment method 3 of the prior document. In this case, input controls for long sound, voiced sound and semi-voiced sound may be allocated to any button of the up/down/left move buttons, which is illustrated in FIG. 8-7.

8.4.4 Use of Move Button as Affix Control Button for Inputting Vowels in Arabic

For Arabic, controls for affix type vowels can be distributed to any button(s) of the up/down/left move buttons.

8.4.5 Use of Move Button as Control Button for Thai

For Thai, succession controls for consonant and vowel share one control button as a succession control button. Any one of the up/down/left move buttons may be used as the control button for consonant or vowel. Any one of the up/down/left move buttons may be used as control button for other purpose.

8.4 Use of Move Button as Short-Cut/full Transition Control Button

The third ambiguity may occur between simple codes and full codes in the Concurrent Input Method (CIM). For elimination of the third ambiguity, “short-cut/full” transition control in the unit of words is used. For example, to input a word by SIM during CIM when FIM is the basic character input mode, the user selects “short-cut/full” transition control and inputs a space (or the right move button) and then a simple code. Of course, the order of space and “short-cut/full” transition control can be changed. The “short-cut/full” transition control in the unit of words is assigned to any one of the up/down/left move buttons. And a control for both “short-cut/full” transition control and space input (with the right move button) is arranged at the position of the base lattice element on any one of the up/down/left move buttons. Reference is made to FIG. 8-8.

It is assumed that English alphabet of FIG. 1-1 are allocated to the numeral buttons of FIG. 8-8. If the fully associated simple code “4357” of the target word “help” is input in the full input mode set as the basic character input mode, the entry is given as “˜full code input+[\hat{ }]+[4]+[3]+[5]+[7]+[>]+full code input ˜”. That is, the “short-cut/full” transition function and the space input function are combined together while the move-related function of the up move button [\hat{ }] is suppressed. Thus, upon selection of button [\hat{ }], the system recognizes “[4]+ . . . ” as a simple code instead of a full code and recommends the user the words most corresponding to input [4] with reference to the index. After the input of [4]+[3]+[5]+[7], selection of a space button (i.e., [>]) ends the word and ends the “short-cut/full” mode transition, and causes the system to wait for the input of another full code. After the input of the simple code “4357”, selection of button [\hat{ }] causes the system to recognize the end of the word, determine the word “help” corresponding to the simple code “4357” and wait for the input of another simple code.

The third ambiguity may occur between simple and full codes as described in the prior document when using only the right move button (i.e., the space button) in CIM. To avoid the third ambiguity in this case, the system checks, in response to every input of the button, whether a simple code exists in the index or a full code is formed according to predetermined FIM. The use of a button combining word-based “short-cut/full” mode transition and space input allows the system to determine in advance whether the input value is simple code or full code. This reduces the number of calculations and searching steps to enhance the performance of the system.

8.6 Use of Move Button as Addition/Subtraction/Multiplication/Division Buttons in Calculation Mode

Irrespective of their position, four move buttons are to be used as addition (+), subtraction (−), multiplication (×) and division (/) buttons, which are most frequently used in the calculation mode. If not specifically limited, the symbols for addition, subtraction, multiplication and division may not be marked on the buttons because the calculation function is not so frequently used as the character input function. The individual buttons are to be used as move buttons or control buttons in the character input mode.

Also, operators used in the calculation function can be assigned to the addition, subtraction, multiplication and division buttons and selected by the (hiding) repeat selection method. This makes the use of the fact that operators (binomial operators) frequently used in the calculation mode rarely repeat. For example, 2++1 is nonexistent. 2⁴ is exploded as 2××4, so that the “square” operator is selected with two strokes of the multiplication (×) button. That is, the multiplication button (×) is selected twice as if the square operator (××) exists as the subsequent operator. Likewise, exploding \sqrt{3} as “3//2”, the “root” operation is selected with two strokes of the division (/) button. Because other binomial operators rarely repeat, they are regarded as the subsequent operators adjunctive to a proper addition, subtraction, multiplication or division button to select the subsequent operators by RSM.

Addition, subtraction and division buttons are assigned to three of the up/down/right/left move buttons, a multiplication being assigned to button [*].

9. Activation of Help Function

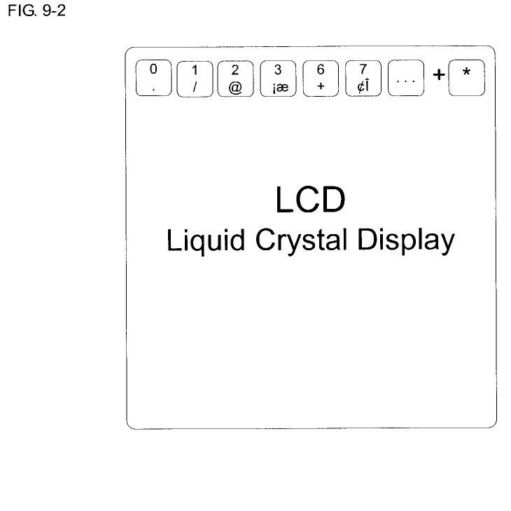

For more convenience in use, it may be possible to display on a screen (i.e., LCD) functions not marked on the up/down/right/left move buttons in the respective input mode. This function uses part of the LCD and it may be useless to those skilled in the function, but may be very helpful to those who have no knowledge of the function of each operator button. In regard to this, reference is made to FIG. 8-1. FIG. 9-1 illustrates another arrangement of the keypad in which the up/down/right/left move buttons are allocated to the right side to the 4*3 keypad as shown in FIG. 8-4.

Expediently, displaying the functions of buttons (i.e., operators allocated to the buttons or symbol groups associated with each button) according to the preference of the user is referred to as “activation of help function”. Activation of help function may be achieved for the individual modes (e.g., character input mode, calculation mode, etc.), or functions necessary in each mode (e.g., the use purpose of numeral buttons or control buttons associated with a symbol group in the character input mode).

Likewise, the function of control buttons or numeral buttons associated with the symbol group as provided in the prior document are also displayed for the purpose of convenience in use, as the user demands. In regard to this, reference is made to FIG. 9-2, which illustrates an example of the display that numeral buttons associated with each symbol group is simplified into icons on the LCD according to the above-described symbol grouping. Expediently, only the symbol first selected from the symbol group associated with each numeral button is marked on the numeral button in the form of icon.

10. Use of Delete Button

The use of a delete button may be associated with “cancellation of final input” as disclosed in the prior document. For example, when the user intended to enter “ [symbol] ” but mistakenly inputted “ [symbol] ” with selection of [1]+[*] (in FIG. ??), selection of the delete button may cancel the final input [*] and restore “ [symbol] ” to “ [symbol] ”. This is useful in entering succession characters by repeatedly pressing control buttons. Successive strokes of the delete button can delete the previously input characters by way of the known method. For example, one stroke of the cancel button restores an input of “ [symbol] ” to “ [symbol] ”, which becomes “ [symbol] ” with another stroke of the cancel button and “ [symbol] ” with further another stroke of the cancel button. For Roman alphabet, a stroke of the delete button on an input of “aba.” (where “a.” is a affixed character comprising “..” and “a”) provides “aba”, which becomes “ab” with another stroke of the delete button and “a” with further another stroke of the delete button. That is, previously formed characters are deleted in the unit of characters.

11. Equalization of Numeral Keypad for Keyboard with Keypad for Telephone

The keypad provided in the prior document and the present invention can be used in every application in the form of telephone keypad, such as a numeral keypad for mobile terminals or standard keyboards, a keypad implemented on the screen in software, a door lock, or the like. The keypad of the prior document and the present invention is different from the numeral keypad provided in the standard keyboard in regard to the arrangement of numeral buttons. It is however apparent that the arrangement of the buttons on the keypad according to the prior document and the present invention is applicable to the keypad provided in the keyboard. For example, characters on the button [1] according to the prior document and the present invention are allocated to the button [1] of the numeral keypad provided in the keyboard. Such a keypad arrangement is applicable for the purposes of character input, the use of simple codes, and memorization of various codes.

To reduce confusion and increase the convenience in use, the numeral arrangement of the telephone keypad is usable in the configuration of the numeral keypad for keyboards. That is, like the keypad of the telephone, the numeral keypad of the keyboard has a numeral arrangement in which buttons [1], [2] and [3] are allocated to the first row of the keypad, buttons [4], [5] and [6] on the second row, buttons [7], [8] and [9] on the third row. In addition, the keypad of the keyboard may have buttons [*] and [#] as that of the telephone.

### Effect of the Invention

The invention is to efficiently input characters on a keypad and, more particularly, to input various symbols by using the hiding control processing method, thereby maintaining a simple arrangement of the keypad.

Furthermore, the present invention produces simple codes using the relation between characters allocated to the keypad and numerals, implements the short-cut input method using the simple codes, and enters target characters and words or phrases with a small number of strokes using the concurrent input method.

With a switching server for interpreting simple codes, the user can input simple codes even when the third server requests words or phrases other than simple codes, and the switching server interprets simple codes input by the user and sends the words or phrases corresponding to the simple codes to the third server, which does not store the simple codes and the words or phrases corresponding to the simple codes.

What is claimed is:

1. A method for entering characters from a keypad, which uses a repeat selection method, the method comprising:
determining a successive stroke delay time (a time for first recognizing two strokes of a button as a second character) differently from a discrete stroke delay time (a time for first recognizing two strokes of a button as two inputs of a first character).

2. A method for entering characters from a keypad, comprising:
grouping the characters into groups each assigned to a button, the characters of a corresponding group comprising a representative character and its succession characters;
selecting a “next control” by pressing a control button; and
entering the succession characters through a combination of the previous character and the “next control”.

3. A method for entering characters from a keypad, which uses a control processing method, the method comprising:
regarding a control as nonexistent if the control to be associated with a representative character is meaningless (wherein a combination of the selected control and the representative character does not form a meaningful character).

4. A method for entering characters from a keypad, which uses a control processing method, the method comprising:
regarding numerals and English alphabet assigned to each button as succession characters, and control processing the succession characters.

5. A method for entering characters from a keypad, which is to input Arabic characters, the method comprising:
grouping characters having meanings of numerals into nine groups of about three characters, the nine groups comprising a first group of characters having the meaning of a numeral starting with 1 on the keypad (i.e., 1, 10, 100 or 1, 10, 100, 1000), a second group of characters having the meaning of a numeral starting with 2 on the keypad (i.e., 2, 20, 200), and third to ninth groups of characters having the meaning of a numeral starting with 3 to 9 on the keypad, respectively;
assigning the individual groups to buttons [1] to [9], respectively;
designating characters of a unit as representative characters in each of the nine groups, the characters of a unit comprising 1-unit characters meaning 1, 2, 3, . . . , or 9, 10-unit characters meaning 10, 20, 30, . . . , or 90, and 100-unit characters meaning 100, 200, 300, . . . , or 900; and
regarding the characters of the other units as succession characters of the representative character and control processing succession characters.

6. A method for entering characters from a keypad, which is to input Korean characters, the method comprising:
grouping ten basic consonants and ten basic vowels into ten pairs of a basic consonant and a basic vowel;
selecting a consonant with one stroke and a vowel with two strokes;
assigning an aspirated consonant control to either a button [*] or a button [#], and a tense consonant control to a button not designated for the aspirated consonant control; and
control processing aspirated consonants and tense consonants.

7. A method for entering characters from a keypad, in which consonants and vowels are grouped into pairs of a consonant and a vowel and are assigned to each button, and a consonant is selected with one stroke of the button, a vowel being selected with two strokes of the button, the method comprising:
grouping consonants and vowels so as to entirely minimize the frequencies of vowel-consonant transition (vowel-consonant coupling in a syllable comprising “consonant+vowel+consonant”) and consonant-vowel transition (consonant-vowel coupling in a syllable comprising “consonant+vowel”), which utmost causes ambiguity.

8. A method for entering characters from a keypad, which is to input Korean characters by selecting characters or controls on the keypad using a repeat selection method, the method comprising:
optionally assigning nine of ten basic consonants other than one destitute of an aspirated consonant or a tense consonant to numeral buttons [1] to [9], respectively;
optionally assigning three vowel elements “—”, “.” and “ [symbol] ” to the three other buttons [*], [0] and [#]; and
arranging each of the basic consonants and vowel elements to be selected with one stroke of the corresponding button.

9. The method as claimed in claim 8, the method comprising:
control processing aspirated consonants and tense consonants such that aspirated consonant control is selected with two strokes of one of the buttons designated for “—” and “ [symbol] ”, and tense consonant control is selected with two strokes of the other button.

10. The method as claimed in claim 9, the method comprising:
regarding basic consonant not assigned to the numeral buttons [1] to [9] as affixed character (i.e., aspirated consonant or tense consonant) of a basic consonant destitute of an aspirated consonant or a tense consonant, and control processing the basic consonant.

11. The method as claimed in claim 10, the method comprising:
additionally assigning basic consonant, not allocated to the buttons [1] to [9], to a button designated “.”; and
selecting the basic consonant with three strokes of the corresponding button.

12. The method as claimed in claim 11, the method comprising:
inputting the tense consonants through a combination of basic consonants.

13. The method as claimed in claim 12, the method comprising:
inputting the aspirated consonant with three strokes of the button designated to the corresponding basic consonant.

14. A method for entering characters from a keypad, which is to input characters through the keypad, the method comprising:
looking up correct words in an index provided on a client or a server in the unit of words (i.e., at the end of each word) when ambiguity occurs while inputting a full code.

15. The method as claimed in claim 14, the method comprising:
first looking up correct words in the index of the client; and
second looking up correct words in the index of the server.

16. A method for using a simple code on a keypad, the method comprising:
designating a corresponding numeral on the keypad as the simple code, the numeral being associated with a consonant included in a given word or phrase.

17. A method for using a simple code on a keypad, the method comprising:
designating a corresponding numeral on a keypad as the simple code, the numeral being associated with initial consonants or vowels of syllables in a given word or phrase.

18. A method for using a simple code on a keypad, the method comprising:
designating a corresponding numeral on a keypad as the simple code, the numeral being associated with initial characters of words in a given phrase.

19. The method as claimed in claims 16, the method comprising:
marking in bold the characters associated with the simple code in the word or phrase.

20. The method as claimed in claim 19, the method comprising:
for English, capitalizing the characters associated with the simple code in the word or phrase and thereby marking them in bold.

21. The method as claimed in claims 16, the method comprising:
a client or a server searching characters corresponding to an input value of the simple code and providing them to the user, thereby making it possible to input a target word or phrase.

22. The method as claimed in claim 21, the method comprising:
grouping simple codes and their corresponding words or phrases; and
when the searching range of the simple codes is limited, searching only the simple codes and their corresponding words or phrases for the input value within the limited searching range.

23. The method as claimed in claim 22, the method comprising:
interpreting the input value, by using a full input method to be first selected, when a basic input mode is designated as a full input mode;
regarding the input value as a simple code when predefined regulations for production of full codes are infringed.

24. The method as claimed in claim 23, the method comprising:
the client downloading the simple codes and a group of words or phrases corresponding to the simple codes from the server.

25. The method as claimed in claim 24, the method comprising:
providing a switching server responsible for interpretation of the simple code.

26. The method as claimed in claim 25, the method comprising:
the switching server interpreting the simple codes input by the user and sending words or phrases corresponding to the simple codes to a server (a third server) equipped with a final application.

27. A method for entering characters from a keypad, which is to input various symbols through the keypad, the method comprising:
dividing the symbols into symbol groups;
assigning the meaning of a specific symbol group to a button on the keypad (i.e, associating a specific symbol group with a button on the keypad;
arranging a plurality of symbol controls (i.e., symbol 1, symbol 2, . . . ) on a button on the keypad;
selecting the symbol controls by using a repeat selection method; and
inputting the symbols of the specific symbol group through a combination of the button, endowed with the meaning of the specific symbol group, and the symbol controls.

28. A method for entering characters from a keypad, which is to input characters with a terminal having up/down/right/left move buttons, the method comprising:
using the up/down/right/left move buttons, not frequently used in a character input mode, as various control buttons.

29. The method as claimed in claim 28, the method comprising:
using the up/down/right/left move buttons as addition, subtraction, multiplication and division buttons in a calculation mode.

30. A method for entering characters from a keypad, which is to input characters on the keypad by using various control processing methods, the method comprising:
simplifying the functions of control buttons into icons and displaying the icons on a screen (liquid crystal display).

31. The method as claimed in claim 30, the method comprising:
simplifying parts of symbols and numerals into icons and displaying the icons on a part of a screen (liquid crystal display), the symbols being included in a symbol group associated with a numeral button.

32. A method for using a simple code on a keypad, the method comprising:
rearranging a predetermined priority in cases where a plurality of words or phrases correspond to a simple code and where the case that the user makes a final selection against the predetermined priority exceeds a predetermined criteria.

33. A keyboard characterized in that the arrangement of numeral buttons on a numeral keypad provided on a standard keyboard is the same as that of numeral buttons on a telephone.
